(19) United States
(12) Patent Application Publication
(10) Pub. No.: US 2026/0178480 A1
(43) Pub. Date: Jun. 25, 2026

(54) MEMORY SYSTEM AND METHOD

(71) Applicant: Kioxia Corporation, Tokyo (JP)

(72) Inventors: Kohei OKUDA, Koganei (JP); Shinichi KANNO, Ota (JP); Tatsuki IZUMI, Ota (JP)

(73) Assignee: Kioxia Corporation, Tokyo (JP)

(21) Appl. No.: 19/237,108

(22) Filed: Jun. 13, 2025

(30) Foreign Application Priority Data
Dec. 19, 2024 (JP) 2024-223795

(51) Int. Cl. G06F 12/02

(52) U.S. Cl. CPC G06F 12/0246; G06F 2212/7204

(57) ABSTRACT

According to one embodiment, a memory system includes memory chips each including first blocks, and a controller. The controller controls parallel access to the memory chips in parallel access units. Each of second blocks that are included in each parallel access unit is one of the first blocks allocated one-by-one from each memory chip. The controller manages information for each memory chip that is specified so that the number of initial defective blocks in each parallel access unit is equal to or smaller than a tolerable number. The controller generates information that corresponds to each parallel access unit and indicates whether the number of defective blocks in each rearranged parallel access unit is equal to or smaller than the tolerable number.

### CROSS-REFERENCE TO RELATED APPLICATIONS

This application is based upon and claims the benefit of priority from Japanese Patent Application No. 2024-223795, filed Dec. 19, 2024, the entire contents of which are incorporated herein by reference.

### FIELD

Embodiments described herein relate generally to a memory system including a nonvolatile memory.

### BACKGROUND

In recent years, memory systems that include a nonvolatile memory have been widely used. As one of such memory systems, a solid state drive (SSD) that includes a NAND flash memory is known. The SSD is used as a data storage of various computing devices and information processing systems.

The memory system, which includes the nonvolatile memory, includes, for example, a plurality of nonvolatile memory chips. In the memory system, for example, a technology of accessing the plurality of nonvolatile memory chips in parallel is used for improving access performance (that is, read performance and write performance). Specifically, a technology of accessing, in parallel, a plurality of physical blocks that are included in the plurality of nonvolatile memory chips, respectively, is used. A parallel access unit that is a set of the plurality of physical blocks accessible in parallel is also referred to as a super block.

In the memory system that includes the plurality of nonvolatile memory chips, a defective block (bad block) that is unavailable for storing data may exist in the plurality of nonvolatile memory chips. In a case where a nonvolatile memory chip includes a defective block in a part of a super block, which is the parallel access unit, the improvement of the access performance may be hindered.

### BRIEF DESCRIPTION OF THE DRAWINGS

FIG. 1 is a block diagram illustrating an example of a configuration of an information processing system that includes a memory system according to an embodiment.

FIG. 2 is a block diagram illustrating an example of a configuration of a NAND flash memory in the memory system according to the embodiment.

FIG. 3 is a block diagram illustrating an example of a configuration of a memory chip in the memory system according to the embodiment.

FIG. 4 is a diagram illustrating an example of a configuration of a super block that is used in the memory system according to the embodiment.

FIG. 5 is a diagram illustrating (a) an example of an occurrence pattern of defective blocks, and (b) an example of a pattern of defective blocks after rearrangement, in a memory system according to a comparative example.

FIG. 6 is a diagram illustrating (a) an example of an occurrence pattern of defective blocks, and (b) an example of a pattern of defective blocks after rearrangement, in the memory system according to the embodiment.

FIG. 7 is a diagram illustrating an example of (a) a plurality of super blocks in which physical block numbers of physical blocks are converted in each of the memory chips, and (b) conversion information used for the conversion, in the memory system according to the embodiment.

FIG. 8 is a diagram illustrating (a) an example of physical block numbers before conversion, and (b) a first example, (c) a second example, and (d) a third example of physical block numbers after the conversion using the conversion information, in a memory chip of the memory system according to the embodiment.

FIG. 9 is a diagram illustrating an example of management tables used in the memory system according to the embodiment.

FIG. 10 is a diagram illustrating another example of the management tables used in the memory system according to the embodiment.

FIG. 11 is a diagram illustrating an example of a configuration of a super block identified based on a sub-table, in the memory system according to the embodiment.

FIG. 12 is a flowchart illustrating an example of the procedure of a conversion information generation process executed in a host device that is connected to the memory system according to the embodiment.

FIG. 13 is a flowchart illustrating an example of the procedure of a conversion and management information setting process executed in the memory system according to the embodiment.

FIG. 14 is a flowchart illustrating an example of the procedure of a defective block management process executed in the memory system according to the embodiment.

FIG. 15 is a flowchart illustrating an example of the procedure of an access control process executed in the memory system according to the embodiment.

### DETAILED DESCRIPTION

In general, according to one embodiment, a memory system includes a plurality of nonvolatile memory chips and a controller. The plurality of nonvolatile memory chips each include a plurality of first blocks. One or more of the plurality of first blocks of each of one or more of the plurality of nonvolatile memory chips are initial defective blocks. The controller is electrically connected to the plurality of nonvolatile memory chips. The controller is configured to access the plurality of nonvolatile memory chips in parallel. The controller is further configured to assign a plurality of first block addresses to the plurality of first blocks of each of the plurality of nonvolatile memory chips, respectively. The controller is further configured to control parallel access to the plurality of nonvolatile memory chips in a plurality of parallel access units. Each of the plurality of parallel access units includes a plurality of second blocks. Each of the plurality of second blocks of each of the plurality of parallel access units is one of the plurality of first blocks allocated one-by-one from each of the plurality of nonvolatile memory chips. The controller is further configured to manage a plurality of pieces of conversion information that correspond to the plurality of nonvolatile memory chips, respectively. Each of the plurality of pieces of conversion information is specified so that the number of initial defective blocks included in each of the plurality of parallel access units is equal to or smaller than a tolerable number. The controller is further configured to rearrange the plurality of parallel access units into a plurality of rearranged parallel access units respectively, by converting, based on the plurality of pieces of conversion information, one or more of the plurality of second blocks included in each of the plurality of parallel access units, into one or more third blocks. The controller is further configured to generate a plurality of pieces of management information that correspond to the plurality of parallel access units, respectively. Each of the plurality of pieces of management information indicates whether or not the number of defective blocks included in each of the plurality of rearranged parallel access units is equal to or smaller than the tolerable number.

Various embodiments will be described hereinafter with reference to the accompanying drawings.

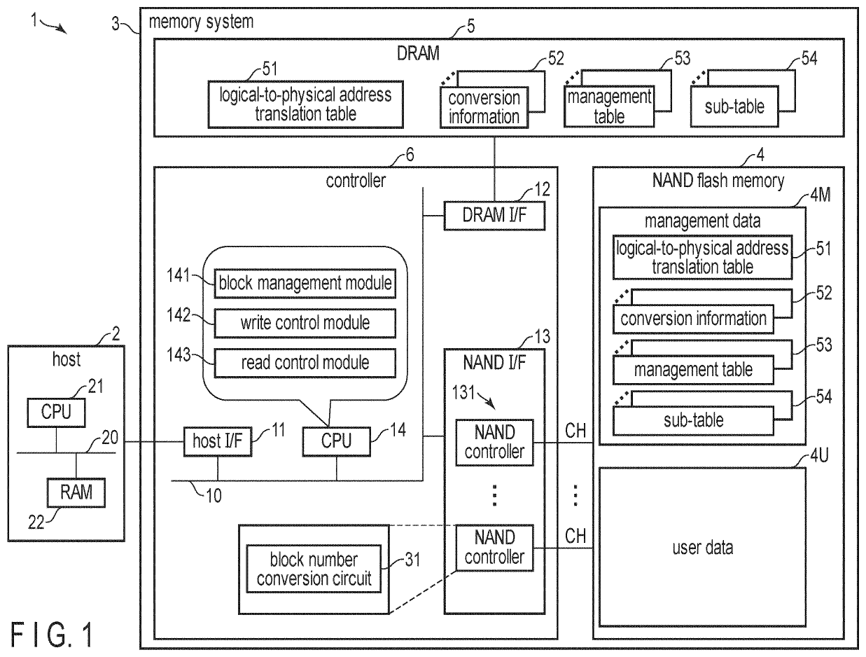

First, an example of a configuration of an information processing system that includes a memory system according to an embodiment will be described with reference to FIG. 1. The information processing system 1 includes, for example, a host device 2 and a memory system 3.

The host device 2 may be a storage server that stores a large amount of various data to the memory system 3, or a personal computer. Hereinafter, the host device 2 is also referred to as a host 2.

The memory system 3 is a storage device configured to write data into a nonvolatile memory and read data from the nonvolatile memory. The memory system 3 is also referred to as a storage device. The nonvolatile memory is, for example, a NAND flash memory 4. The memory system 3 is implemented as, for example, a solid state drive (SSD) including the NAND flash memory 4.

The memory system 3 may be used as a storage of the host 2. The memory system 3 may be provided inside the host 2 or may be connected to the host 2 via a cable or a network.

An interface for connecting the host 2 and the memory system 3 conforms to standards such as PCI Express™ (PCIe™), Ethernet™, Fibre channel, or NVM Express™ (NVMe™). That is, the memory system 3 conforms to at least one of these standards.

The host 2 includes, for example, a central processing unit (CPU) 21 and a random access memory (RAM) 22. The CPU 21 and the RAM 22 are connected via, for example, a bus 20.

The CPU 21 is, for example, at least one processor. The CPU 21 controls operations of various components of the host 2.

The RAM 22 is, for example, a volatile memory. The RAM 22 is, for example, a dynamic random access memory (DRAM) or a static random access memory (SRAM).

The memory system 3 includes, for example, the NAND flash memory 4, a DRAM 5, and a controller 6.

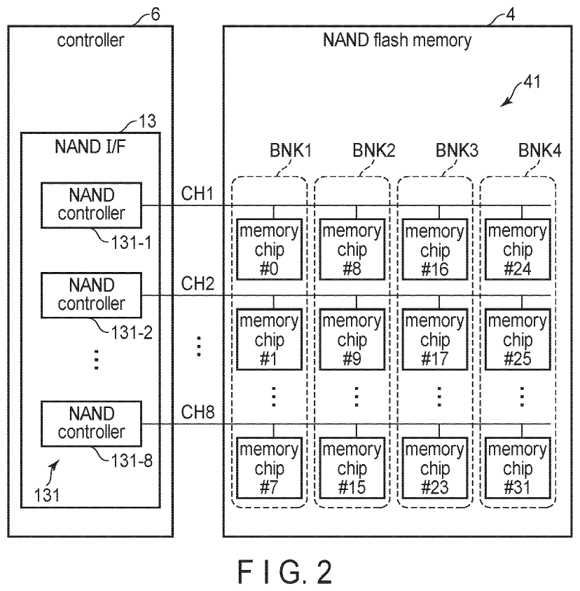

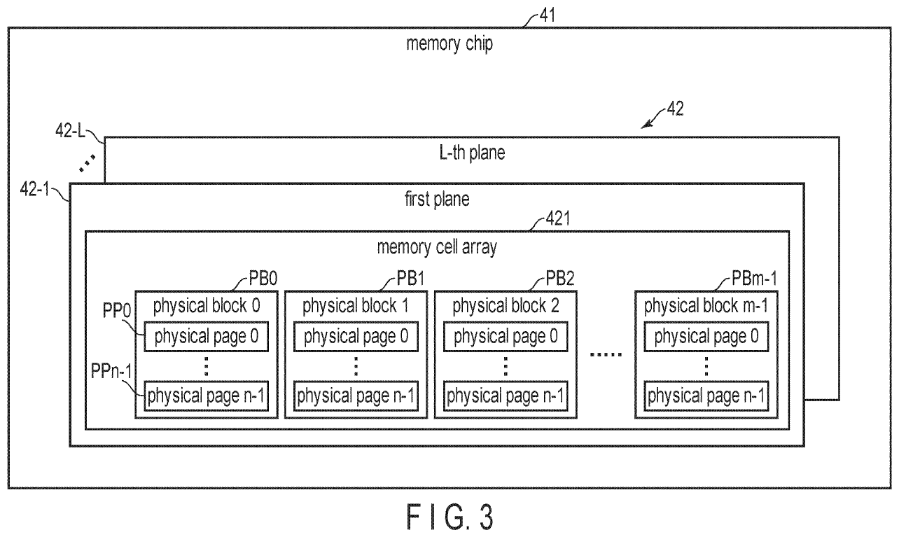

A configuration of the NAND flash memory 4 will be described with reference to FIGS. 2 and 3.

FIG. 2 is a block diagram illustrating an example of a configuration of the NAND flash memory 4.

The NAND flash memory 4 includes, for example, a plurality of NAND memory chips 41. The NAND memory chips 41 are nonvolatile memory chips. Hereinafter, a NAND memory chip 41 is also simply referred to as a memory chip 41. Each of the plurality of memory chips 41 is capable of operating independently. That is, the plurality of memory chips 41 each function as a unit operable in parallel. The plurality of memory chips 41 are, for example, 32 memory chips #0 to #31. Each of the plurality of memory chips is connected to the controller 6 via any one of a plurality of channels CH, for example. The plurality of channels CH are, for example, eight channels CH1 to CH8. The plurality of memory chips 41 compose, for example, a plurality of banks. Each of the banks is a unit in which at least two of the plurality of memory chips 41 are operated in parallel by an interleaving operation. The plurality of banks are, for example, four banks BNK1, BNK2, BNK3, and BNK4. Each of the four banks BNK1, BNK2, BNK3, and BNK4 includes, for example, eight memory chips.

The controller 6 is electrically connected to the plurality of memory chips 41 via the plurality of channels. The controller 6 includes a NAND interface circuit (NAND I/F) 13. The NAND I/F 13 is a memory control circuit configured to control the NAND flash memory 4. The NAND I/F 13 includes, for example, as many NAND controllers 131 as the channels. The NAND controllers 131 are, for example, eight NAND controllers 131-1, 131-2, . . . , and 131-8 (hereinafter, referred to as NAND controllers 131-1 to 131-8). The eight NAND controllers 131-1 to 131-8 are connected to the eight channels CH1 to CH8, respectively. Each of the NAND controllers 131-1 to 131-8 may be connected to some of the plurality of memory chips 41 in the NAND flash memory 4 via the connected channel. By operating the plurality of memory chips 41 in parallel, it is possible to broaden an access bandwidth between the controller 6 and the NAND flash memory 4.

In the example illustrated in FIG. 2, the memory chips #0, #8, #16, and #24 are connected to the NAND controller 131-1 via the channel CH1. The memory chips #1, #9, #17, and #25 are connected to the NAND controller 131-2 via the channel CH2. The memory chips #7, #15, #23, and #31 are connected to the NAND controller 131-8 via the channel CH8. In addition, the memory chips #0 to #7 compose the bank BNK1. The memory chips #8 to #15 compose the bank BNK2. The memory chips #16 to #23 compose the bank BNK3. The memory chips #24 to #31 compose the bank BNK4.

Hereinafter, one of the plurality of memory chips 41 that is not specified is also referred to as a memory chip 41.

FIG. 3 illustrates an example of a configuration of the memory chip 41. The memory chip 41 includes, for example, L planes 42. Here, L is, for example, an integer of 1 or larger. Each of the L planes 42 is a unit that performs a data write operation and a data read operation. The number of the planes 42 included in the memory chip 41 is freely determined. FIG. 3 illustrates a case where the memory chip 41 includes a first plane 42-1, . . . , and an L-th plane 42-L. Hereinafter, one of the L planes 42 that is not specified is also referred to as a plane 42.

The plane 42 includes a memory cell array 421. The memory cell array 421 includes multiple physical blocks PB0, PB1, PB2, . . . , and PBm-1 each including a plurality of memory cells arranged in matrix. Each of the physical blocks PB0, PB1, PB2, . . . , and PBm-1 may function as a unit of a data erase operation. The physical block is also referred to as an erase block. Each of the physical blocks PB0, PB1, PB2, . . . , and PBm-1 includes multiple physical pages PP0, . . . , and PPn-1. Each of the physical pages PP0, . . . , and PPn-1 includes a plurality of memory cells connected to a single word line. The physical pages PP0, . . . , and PPn-1 each function as a unit of a data write operation and a data read operation. Note that a word line may also function as a unit of a data write operation and a data read operation. In general, access performance of a nonvolatile memory chip includes read performance and write performance. The read performance of the nonvolatile memory chip refers to a capability (e.g., speed) of reading data stored in a physical block or a physical page in the nonvolatile memory chip (for example, a reading time). The write performance of the nonvolatile memory chip refers to a capability (e.g., speed) of writing data into a physical block or a physical page in the nonvolatile memory chip (for example, a writing time). In the embodiment, the access performance mainly refers to the write performance.

Physical block numbers are assigned to the physical blocks PB0, PB1, PB2, . . . , and PBm-1, respectively, in a specific order by the controller 6, for example. Specifically, for example, numbers in an ascending order such as 0, 1, 2, . . . , and m-1 are respectively assigned to the physical blocks PB0, PB1, PB2, . . . , and PBm-1 that are arranged according to physical coordinates in the memory cell array 421. Alternatively, numbers in a descending order such as m-1, . . . , 2, 1, and 0 may be respectively assigned to the physical blocks PB0, PB1, PB2, . . . , and PBm-1. In addition, the physical block numbers may be assigned to the physical blocks for each plane 42 such that two or more planes 42 have the same physical block number assigned thereto, or may be assigned across the planes 42 of the memory chip 41 such that, in one memory chip 41, only one plane 42 has a certain physical block number assigned thereto. The physical block number is also referred to as a block address. The physical block number is not limited to a number, and may be information in any format by which a corresponding physical block is uniquely identifiable.

The tolerable maximum number of program/erase cycles (maximum number of P/E cycles) for each of the physical blocks PB0, PB1, PB2, . . . , and PBm-1 is limited. One P/E cycle of a physical block includes a data erase operation to erase data stored in all of the memory cells in the physical block and a data program operation to write data in each page of the physical block.

In the memory system 3, a plurality of super blocks may be arranged. Each of the super blocks is a set of physical blocks that are obtained by selecting at least one physical block from each of the memory chips 41 that are operable in parallel. That is, the super blocks are a plurality of parallel access units that are controlled by the controller 6. The controller 6 controls the super blocks each including the physical blocks that belong to the memory chips 41 (or the planes 42 of the memory chips 41), respectively. The super block is also referred to as a logical block or a block group. In addition, a set of physical pages that are obtained by selecting one physical page from each of physical blocks that belong to the same super block is referred to as a super page or a logical page.

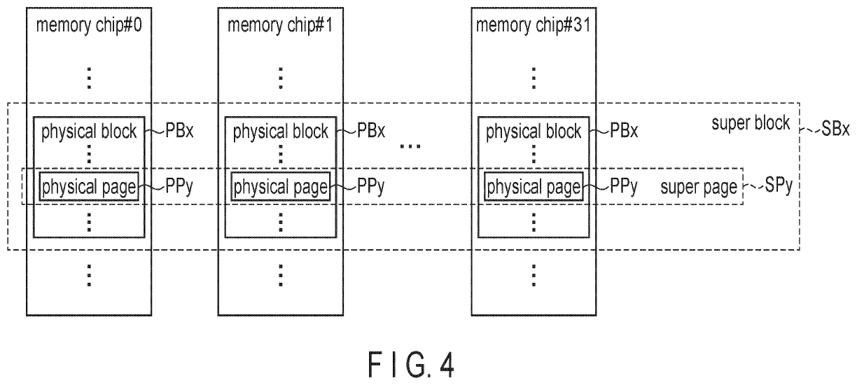

FIG. 4 illustrates an example of a configuration of a super block. Here, a case where the number of channels is eight, the number of banks is four, and one physical block is selected from each of memory chips that are operable in parallel will be described. A configuration of the eight channels × the four banks corresponds to the 32 memory chips #0 to #31. In this case, one super block includes a total of 32 physical blocks that are selected one by one from the 32 memory chips #0 to #31.

In FIG. 4, one super block SBx including 32 physical blocks PBx is illustrated. Here, the super block SBx is composed of x-th physical blocks PBx of each of the memory chips #0 to #31. FIG. 4 also illustrates one super page SPy that is composed of physical pages PPy of each of the 32 physical blocks PBx. The controller 6 may execute data write operations for the 32 physical pages PPy in parallel, which belong to the super page SPy. In addition, the controller 6 may execute data read operations for the 32 physical pages PPy in parallel, which belong to the super page SPy.

Note that in a case where each memory chip 41 includes multiple planes 42 (that is, in the case of the memory chip 41 having a multi-plane configuration), a super block includes physical blocks respectively selected from the planes 42, each of which includes a plurality of physical blocks. For example, in a case where each of the memory chips #0 to #31 includes two planes, one super block SBx includes a total of 64 physical blocks PBx that are obtained by selecting one physical block from each of 64 planes 42 corresponding to the NAND flash memory chips #0 to #31. In this case, one super page SPy includes physical pages PPy of the respective 64 physical blocks PBx. The controller 6 may execute data write operations for the 64 physical pages PPy in parallel, which belong to the super page SPy. In addition, the controller 6 may execute data read operations for the 64 physical pages PPy in parallel, which belong to the super page SPy. Hereinafter, the physical block and the super block may be generically and simply referred to as a block.

The description returns to FIG. 1.

The DRAM 5 is a volatile memory. A storage area of the DRAM 5 is allocated as, for example, cache areas of a logical-to-physical address translation table 51, a plurality of pieces of conversion information 52, a plurality of management tables 53, and one or more sub-tables 54. The storage area of the DRAM 5 may be further allocated as a storage area of firmware (FW) and a buffer area for temporarily storing user data 4U. The FW is a program for controlling an operation of the controller 6. The FW is loaded from the NAND flash memory 4 to the DRAM 5, for example. The user data 4U is data requested to be written by the host 2.

The logical-to-physical address translation table 51 is a table for managing mapping between each logical address and each physical address of the NAND flash memory 4. The logical address is used by the host 2 for addressing a storage area of the memory system 3. The logical address is, for example, a logical block address (LBA).

The plurality of pieces of conversion information 52 correspond to, for example, the plurality of memory chips 41, respectively. For example, the pieces of conversion information 52 are generated in advance outside the memory system 3 (for example, inside the host 2), based on, for example, a test result for each memory chip 41 and the configuration of the memory chips 41 in the NAND flash memory 4. The test result for each memory chip 41 includes, for example, information regarding an initial defective block included in the memory chip 41. The defective block is a physical block on which neither a data read operation nor a data write operation can be correctly performed. The initial defective block is a defective block that occurs in a manufacturing process of the NAND flash memory 4.

Each of the pieces of conversion information 52 is information indicative of an operation rule for converting a physical block number of a physical block in the corresponding memory chip 41 into another physical block number. A plurality of operation rules respectively indicated by the pieces of conversion information 52 are specified so as to evenly level the numbers of initial defective blocks that belong to the respective super blocks (i.e., parallel access units). The leveling of the numbers of initial defective blocks that belong to the respective super blocks means, for example, minimizing a difference among the numbers of initial defective blocks that belong to the respective super blocks. The difference among the numbers of initial defective blocks is ideally zero or one, but may be one or more. Specifically, the leveling according to the operation rules is specified so that, for example, the number of initial defective blocks that belong to each of the super blocks is equal to or smaller than a tolerable number. The tolerable number is an upper limit of the number of defective blocks tolerated to belong to each super block, and is appropriately determined according to a specification of the memory system.

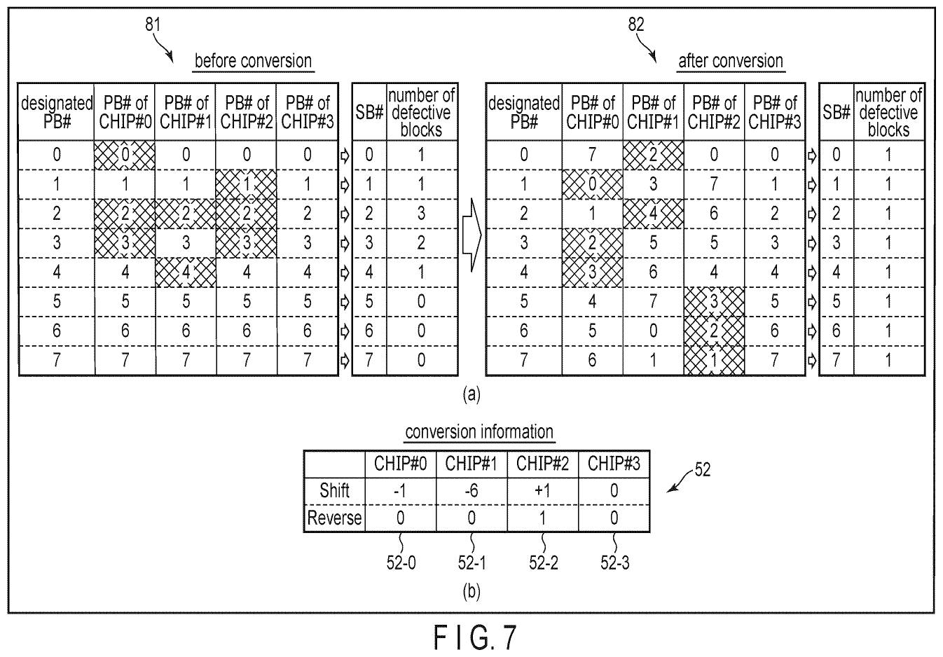

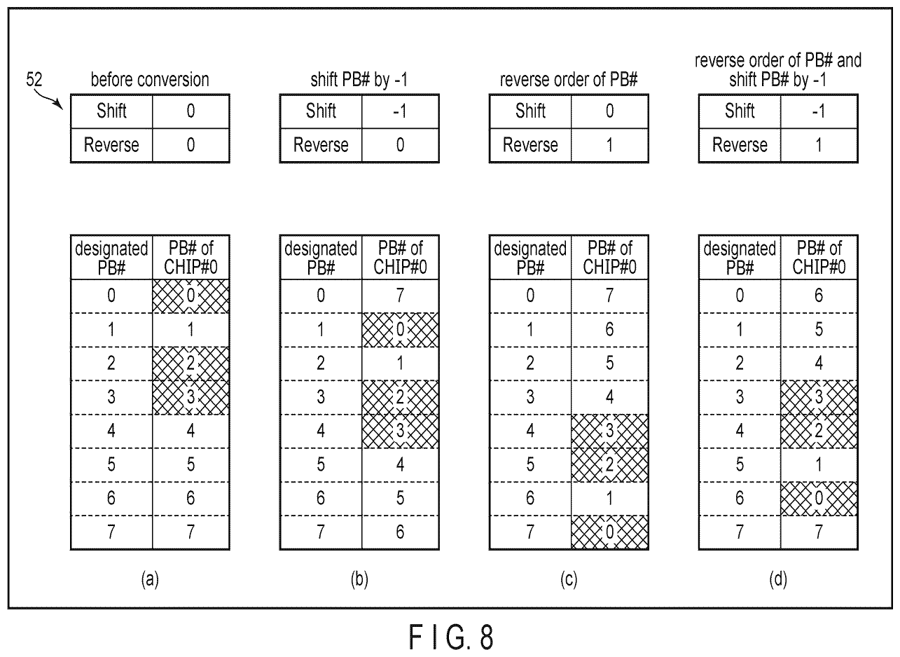

A plurality of physical block numbers respectively assigned to the plurality of physical blocks that belong to a super block may be converted into a plurality of different or identical physical block numbers, respectively, based on the plurality of pieces of conversion information 52 (that is, the conversion information 52 for each memory chip 41). A plurality of physical blocks to which the plurality of physical block numbers obtained by the conversion are assigned belong to a super block. This super block is referred to as a rearranged super block. A super block, which includes a plurality of physical blocks, is rearranged as a rearranged super block, which includes a plurality of physical blocks identified by the conversion of the physical block numbers based on the plurality of pieces of conversion information 52. That is, the rearranged super block is a super block rearranged based on the pieces of conversion information 52. Therefore, in a plurality of rearranged super blocks that are obtained by rearranging the plurality of super blocks on the basis of the plurality of pieces of conversion information 52, the numbers of initial defective blocks that belong to the plurality of rearranged super blocks are leveled. Hereinafter, a rearranged super block obtained by rearranging a super block on the basis of the pieces of conversion information 52 is also simply referred to as a rearranged super block corresponding to a super block. Specific examples of a configuration of the conversion information 52 and the conversion of a physical block number based on the conversion information 52 will be described below with reference to FIGS. 7 and 8.

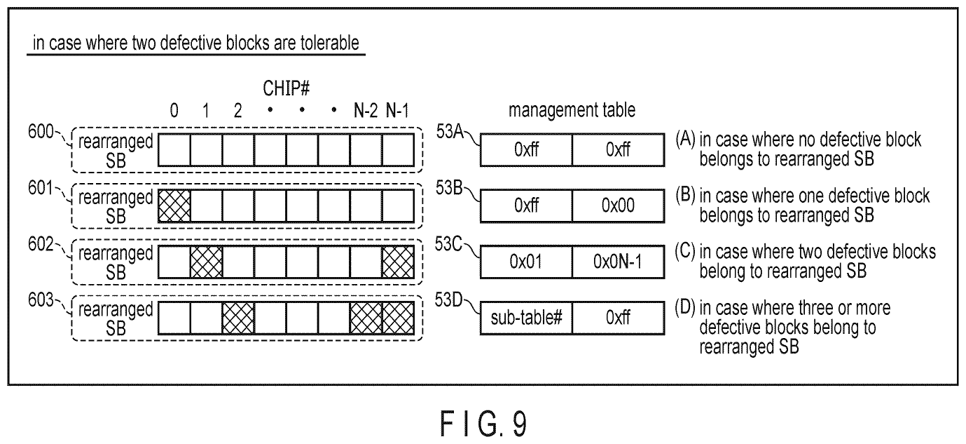

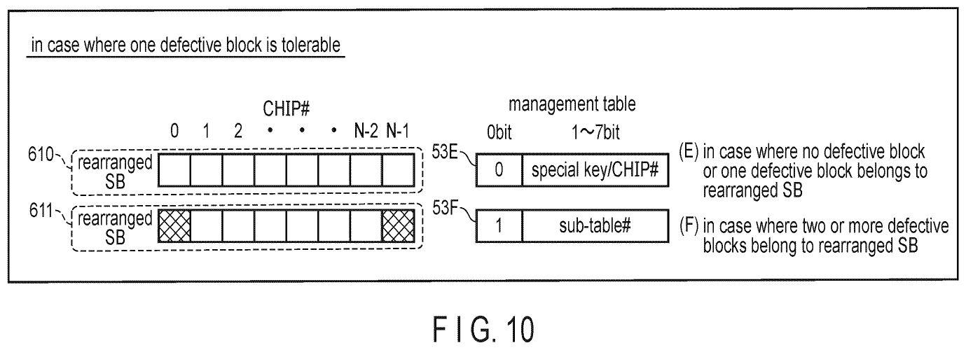

The plurality of management tables 53 correspond to the plurality of super blocks, respectively. Each management table 53 is information (management information) that indicates whether or not the number of defective blocks that belong to a rearranged super block, which is obtained by rearranging physical blocks that belongs to the corresponding super block, is equal to or smaller than the tolerable number. A specific example of a configuration of the management table 53 will be described below with reference to FIGS. 9 and 10.

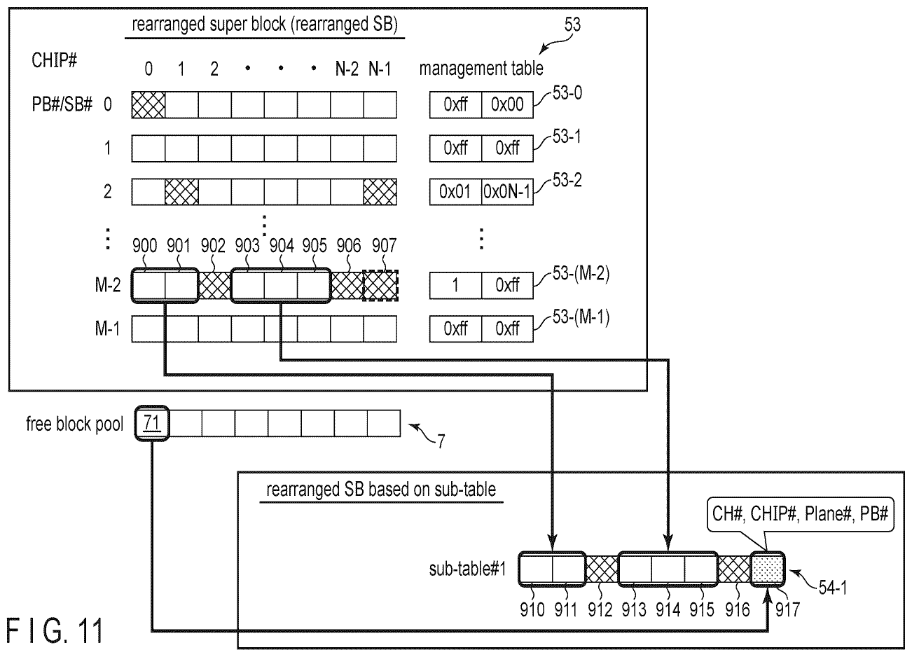

The one or more sub-tables 54 are associated with one or more management tables 53, respectively, among the plurality of management tables 53. Each sub-table 54 indicates a plurality of physical blocks that actually belong to a rearranged super block (that is, a super block corresponding to the rearranged super block) in a case where the number of defective blocks that belong to the rearranged super block exceeds the tolerable number. The sub-table 54 is subordinate information generated when the number of defective blocks that belong to the rearranged super block has exceeded the tolerable number. That is, while the number of defective blocks that belong to the rearranged super block exceeds the tolerable number, the plurality of physical blocks that actually belong to the corresponding super block are identified by using the sub-table 54 that is associated with the management table 53 corresponding to this super block. Therefore, each physical block that belong to the super block is capable of being changed by using the sub-table 54. This enables to reduce performance variation among the super blocks caused by the occurrence of in-service defective blocks and to extend the life of the memory system 3. An example of a configuration of the sub-table 54 will be described below with reference to FIG. 11.

The controller 6 may be implemented with a circuit such as a system-on-a-chip (SoC). The controller 6 may be implemented with a plurality of semiconductor chips. The controller 6 is electrically connected to the NAND flash memory 4 and is configured to control the NAND flash memory 4. The function of each unit of the controller 6 may be realized by dedicated hardware in the controller 6 or may be realized by a processor executing the FW.

The controller 6 may function as a flash translation layer (FTL) configured to execute data management and block management of the NAND flash memory 4. The data management executed by the FTL includes (1) management of mapping data indicative of a relationship between each logical address and each physical address of the NAND flash memory 4, and (2) process to hide a difference between data read/write operations in units of page and data erase operations in units of block. The block management includes management of defective blocks, wear-leveling, and garbage collection (GC).

The management of the mapping data between each logical address and each physical address is executed by using, for example, the logical-to-physical address translation table 51. The controller 6 uses the logical-to-physical address translation table 51 to manage the mapping between each logical address and each physical address in a certain management size. A physical address corresponding to a logical address indicates a physical memory location in the NAND flash memory 4 to which data of the logical address is stored. The controller 6 manages, by using the logical-to-physical address translation table 51, multiple storage areas that are obtained by logically dividing the storage area of the NAND flash memory 4. The size of each of the storage areas is the management size described above. The storage areas correspond to multiple logical addresses, respectively. That is, each of the storage areas is identified by one logical address. The logical-to-physical address translation table 51 may be loaded from the NAND flash memory 4 to the DRAM 5 when the memory system 3 is boot up.

The data write operation into one page is executable only once in a single P/E cycle. Thus, the controller 6 writes updated data corresponding to a logical address not to an original physical memory location in which previous data corresponding to the logical address is stored but to a different physical memory location. Then, the controller 6 updates the logical-to-physical address translation table 51 to associate the logical address with this different physical memory location rather than the original physical memory location and to invalidate the previous data (i.e., data stored in the original physical memory location). Data to which the logical-to-physical address translation table 51 refers (that is, data associated with a logical address) is referred to as valid data. Furthermore, data not associated with any logical address is referred to as invalid data. The valid data is data to be possibly read by the host 2 later. The invalid data is data not to be read by the host 2 anymore.

The blocks in the NAND flash memory 4 are roughly classified into active blocks and free blocks. Each active block stores valid data, and more data is not newly writable to it. Each free block does not store valid data, and becomes available for writing new data after a data erase operation is performed. That is, each free block is used as a new write destination block through a data erase operation. The write destination block may store valid data. Each active block is managed by using a list called an active block pool. Each free block is managed by using a list called a free block pool.

In addition, data stored in the NAND flash memory 4 is roughly classified into management data 4M and the user data 4U.

The management data 4M is various information for managing a state of the memory system 3 and controlling an operation of the memory system 3. The management data 4M is, for example, the logical-to-physical address translation table 51, the plurality of pieces of conversion information 52, the plurality of management tables 53, and the one or more sub-tables 54. Note that at least one of the logical-to-physical address translation table 51, the plurality of pieces of conversion information 52, the plurality of management tables 53, and the one or more sub-tables 54 may be stored in a nonvolatile memory in the memory system 3 other than the NAND flash memory 4.

As described above, the user data 4U is data requested to be written by the host 2.

The garbage collection is a process for increasing the number of free blocks in the NAND flash memory 4. Specifically, the garbage collection is a process of copying valid data in some active blocks in which valid data and invalid data are mixed into another block. The blocks that store only invalid data after the valid data is copied to said another block are released as free blocks. Therefore, the number of free blocks in the NAND flash memory 4 can be increased by performing the garbage collection.

The controller 6 includes, for example, a host interface circuit (host I/F) 11, a DRAM interface circuit (DRAM I/F) 12, the NAND interface circuit (NAND I/F) 13, and a CPU 14. The host I/F 11, the DRAM I/F 12, the NAND I/F 13, and the CPU 14 are connected via, for example, a bus 10. The controller 6 may further include an SRAM not illustrated. The SRAM is a volatile memory. The SRAM is connected to each unit of the controller 6 via, for example, the bus 10. The SRAM may store at least a part of data (information) stored in the DRAM 5 described above.

The host I/F 11 is a circuit configured to receive various commands (for example, an input/output (I/O) command and a control command) and data from the host 2 and transmit data and a response to a command to the host 2. The I/O command is, for example, an access command such as a write command or a read command. The write command is a command that requests the writing of user data to a designated logical address. The read command is a command that requests the reading of user data from a designated logical address. The control command includes, for example, an unmap command (or referred to as a trim command or a deallocate command). The unmap command is a command that requests invalidation of data corresponding to a designated logical address.

The DRAM I/F 12 is a DRAM control circuit configured to control access to the DRAM 5.

As described above, the NAND I/F 13 is a memory control circuit configured to control the NAND flash memory 4. Each of the plurality of NAND controllers 131 of the NAND I/F 13 includes, for example, a block number conversion circuit 31.

In a case where access to a physical block (hereinafter, also referred to as a target physical block) is requested, the block number conversion circuit 31 determines a physical block to be actually accessed by using the conversion information 52 for each memory chip 41, the management table 53 for each super block, and the sub-table 54 associated with any one of the management tables 53.

Specifically, for example, information by which the target physical block is identifiable is input to the block number conversion circuit 31. This information includes, for example, a chip number of a memory chip 41 (hereinafter, also referred to as a memory chip A) that includes the target physical block and a physical block number of the target physical block. The block number conversion circuit 31 converts the physical block number of the target physical block that belongs to a super block into a physical block number (hereinafter, referred to as a physical block number A) of a physical block that belongs to a rearranged super block corresponding to the super block by using the conversion information 52 corresponding to the memory chip A. In addition, the block number conversion circuit 31 determines whether or not the number of defective blocks that belong to the corresponding rearranged super block is equal to or smaller than the tolerable number by using the management table 53 of the super block to which the target physical block belongs.

In a case where the number of defective blocks that belong to the rearranged super block is equal to or smaller than the tolerable number, the block number conversion circuit 31 sends, to the memory chip A, the physical block number A obtained by the conversion using the conversion information 52. That is, the block number conversion circuit 31 determines, as the physical block to be actually accessed, a physical block to which the physical block number A is assigned. The block number conversion circuit 31 instructs a target memory chip 41 (i.e., the memory chip A) to access the physical block to which the physical block number A is assigned.

In a case where the number of defective blocks that belong to the rearranged super block exceeds the tolerable number, the block number conversion circuit 31 acquires, by using the sub-table 54 associated with the management table 53 of the corresponding super block, information indicative of a physical block that actually belongs to the super block (hereinafter, also referred to as block information). The block information indicates, for example, a chip number of a memory chip 41 that includes the corresponding physical block and a physical block number assigned to the physical block. The block information may further include a channel number of a channel to which the memory chip 41, which includes the corresponding physical block, is connected, and a plane number of a plane 42 of the memory chip 41 that includes the physical block. The block number conversion circuit 31 determines, as the physical block to be actually accessed, the physical block identified based on the acquired block information. The block number conversion circuit 31 instructs the memory chip 41 identified based on the block information to access the physical block identified based on the block information.

Note that the block number conversion circuit 31 may be provided inside the controller 6 other than inside the NAND controller 131.

The CPU 14 is a processor configured to control the host I/F 11, the DRAM I/F 12, and the NAND I/F 13. The CPU 14 performs various processes by executing the FW loaded from the NAND flash memory 4 to the DRAM 5. The FW is a control program that includes instructions for causing the CPU 14 to execute the various processes. The CPU 14 may perform command processes to process various commands from the host 2. The operation of the CPU 14 is controlled by the FW executed by the CPU 14.

The CPU 14 functions as, for example, a block management module 141, a write control module 142, and a read control module 143. The CPU 14 functions as each of these modules, for example, by executing the FW. A part or all of each of the block management module 141, the write control module 142, and the read control module 143 may be realized by dedicated hardware in the controller 6. The block management module 141, the write control module 142, and the read control module 143 control the plurality of super blocks in cooperation with the NAND I/F 13.

The block management module 141 manages the plurality of physical blocks included in each of the plurality of memory chips 41 of the NAND flash memory 4.

Specifically, the block management module 141 manages active blocks and free blocks that are included in the NAND flash memory 4. The active blocks include, for example, an active physical block and an active super block. The free blocks include, for example, a free physical block and a free super block. The block management module 141 manages the active blocks by using, for example, the active block pool. The block management module 141 manages the free blocks by using, for example, the free block pool.

The block management module 141 assigns a plurality of physical block numbers (block addresses) to the plurality of physical blocks, respectively, which are included in each memory chip 41, in a specific order. The block management module 141 manages the plurality of super blocks (parallel access units) and the plurality of physical blocks that belong to each of the plurality of super blocks.

The block management module 141 receives the conversion information 52 for each memory chip 41 from the host 2 via the host I/F 11, for example. A timing of receiving the conversion information 52 is, for example, any timing in a manufacturing process of the memory system 3. The block management module 141 stores the received conversion information 52 in the NAND flash memory 4 as the management data 4M (that is, stores it in a non-volatile manner). Then, the block management module 141 sets the conversion information 52 for the block number conversion circuit 31 of each NAND controller 131. Specifically, the block management module 141 stores the conversion information 52 in a storage area (not shown) of the block number conversion circuit 31 or stores the conversion information 52 in a storage area accessible by the block number conversion circuit 31 (for example, the DRAM 5), thereby setting the conversion information 52 for the block number conversion circuit 31. Note that for the block number conversion circuit 31 of a NAND controller 131, the conversion information 52 corresponding to each of memory chips 41 to which the NAND controller 131 is connected via a channel CH may be set.

The block management module 141 manages whether or not the number of defective blocks that belong to a rearranged super block is equal to or smaller than the tolerable number. Specifically, the block management module 141 generates the management table 53 for each super block, and stores the management table 53 as the management data 4M in the NAND flash memory 4, for example. When an in-service defective block has occurred, the block management module 141 identifies a rearranged super block to which the in-service defective block belongs. Then, the block management module 141 updates the management table 53 of the super block that corresponds to the identified rearranged super block (also referred to as target management table 53), in accordance with the in-service defective block that has occurred. Note that the in-service defective block is a defective block that occurs after shipment of the memory system 3.

When the number of defective blocks that belong to the rearranged super block has exceeded the tolerable number due to the occurrence of the in-service defective block, the block management module 141 generates a sub-table 54. The block management module 141 associates the generated sub-table 54 with the target management table 53. In addition, the block management module 141 replaces a defective block that belongs to the rearranged super block with a free physical block that is selected from one or more free physical blocks indicated in the free block pool. The block management module 141 sets, in the generated sub-table 54, block information indicative of physical blocks that actually belong to the super block, which includes the free physical block with which the defective block is replaced. Specific examples of an operation for managing the in-service defective block, the management table 53, and the sub-table 54 will be described below with reference to FIGS. 9 to 11.

The write control module 142 controls the writing of data into the NAND flash memory 4 via the NAND I/F 13. Specifically, for example, the write control module 142 selects a free super block from one or more free super blocks that are indicated in the free block pool. The write control module 142 allocates the selected free super block as a write destination super block into which user data received from the host 2 is to be written.

The write control module 142 requests the NAND I/F 13 to execute a process for writing user data received in accordance with a write command from the host 2, into physical blocks of the write destination super block in parallel. Specifically, in accordance with the write command received from the host 2, the write control module 142 requests the NAND I/F 13 to write the user data received from the host 2 into an available physical memory location in the write destination super block. Then, the write control module 142 updates the logical-to-physical address translation table 51 to map a physical address indicative of the physical memory location in which the user data has been written onto a logical address designated in the write command. Note that when the whole of the write destination super block has been filled with data, the write destination super block is managed by the active block pool. In addition, a new write destination super block is allocated by using the free block pool.

The read control module 143 controls the reading of data from the NAND flash memory 4 via the NAND I/F 13. When a read command has been received from the host 2, the read control module 143 requests the NAND I/F 13 to read user data that corresponds to a logical address designated in the read command, from a physical memory location in the super block in which the user data is stored. Specifically, when the read command has been received from the host 2, the read control module 143 acquires a physical address that is mapped to the logical address designated in the read command by referring to the logical-to-physical address translation table 51. The read control module 143 requests the NAND I/F 13 to read the user data from the physical address. Then, the read control module 143 transmits the read user data to the host 2.

With the above configuration, the controller 6 manages the plurality of super blocks by using the conversion information 52 for each memory chip 41. For each super block, the controller 6 manages whether or not the number of defective blocks that belong to the corresponding rearranged super block is equal to or smaller than the tolerable number, by using the management table 53. Furthermore, when the number of defective blocks that belong to a rearranged super block has exceeded the tolerable number, the controller 6 manages physical blocks that actually belong to the corresponding super block by using the sub-table 54. By using the conversion information 52, the management table 53, and the sub-table 54, the controller 6 can control access to each super block at low cost. In addition, it is possible to prevent the access performance from differing among the super blocks by the access control using the conversion information 52. Therefore, in the memory system 3, it is possible to reduce deterioration of performance in access to the NAND flash memory 4.

Here, a configuration of a super block in consideration of an initial defective block in a NAND flash memory of a memory system according to a comparative example will be described.

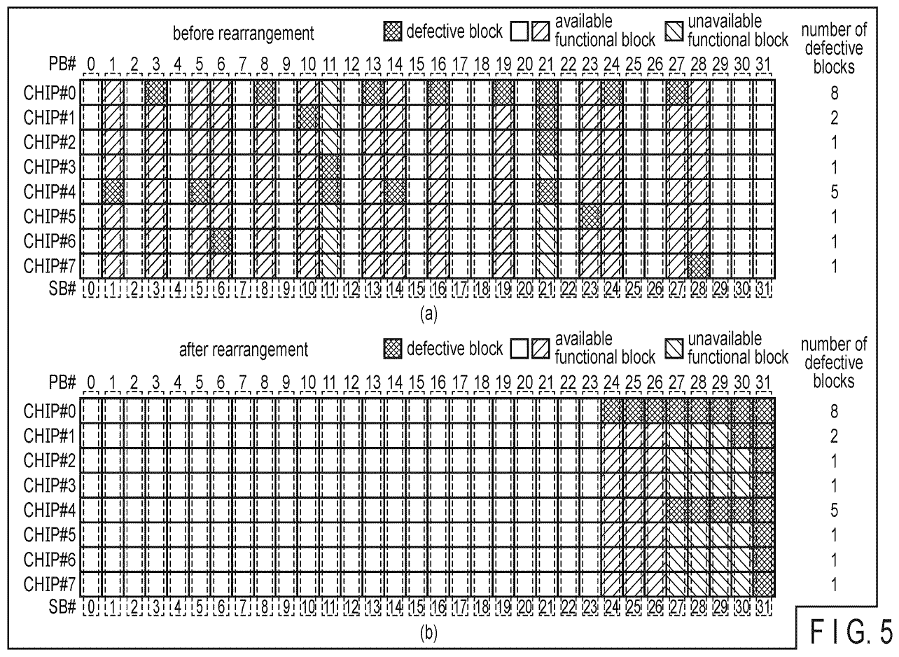

FIG. 5 illustrates (a) an example of an occurrence pattern of defective blocks in a plurality of memory chips (before super block rearrangement), and (b) an example of a defective block pattern after defective blocks are replaced with physical blocks other than the defective blocks in each memory chip (after super block rearrangement), in the memory system according to the comparative example.

Here, it is assumed that a NAND flash memory includes eight memory chips CHIP #0 to CHIP #7. Each of the eight memory chips CHIP #0 to CHIP #7 includes 32 physical blocks PB #0 to PB #31. Among the 32 physical blocks PB #0 to PB #31 included in each of the eight memory chips CHIP #0 to CHIP #7, eight physical blocks that have the same physical block number PB # belong to one super block. A physical block number of each physical block that belongs to one super block is determined based on a super block number by which the super block is identified and a mathematical rule. The super block number is also referred to as a super block address. The mathematical rule is, for example, any rule which can uniquely determine a set of physical block numbers by using the super block number.

By using a method of uniquely determining the set of physical block numbers of respective physical blocks that belong to the super block on the basis of the super block number and the mathematical rule, it is not necessary to provide a dedicated management table for each super block that indicates physical block numbers of respective physical blocks that belong to each super block. Further, by this method, the set of physical block numbers of the respective physical blocks that belong to a super block can be easily identified based on the super block number of the super block.

FIG. 5 illustrates 32 super blocks SB #0 to SB #31. Here, in order to facilitate illustration and understanding, a case where a super block includes a set of physical blocks that each have a physical block number whose value is the same as its super block number (that is, a case where a super block number is equal to a physical block number) is illustrated.

Specifically, the super block SB #0 includes eight physical blocks PB #0 that belong to the memory chips CHIP #0 to CHIP #7, respectively. The super block SB #1 includes eight physical blocks #PB1 that belong to the memory chips CHIP #0 to CHIP #7, respectively. The super block SB #2 includes eight physical blocks #PB2 that belong to the memory chips CHIP #0 to CHIP #7, respectively. The same applies to each of the other super blocks SB #3 to SB #31.

In FIG. 5(a), a block illustrated with cross-hatching is a defective block. The memory chip CHIP #0 includes eight defective blocks. The memory chip CHIP #1 includes two defective blocks. The memory chip CHIP #2 includes one defective block. The memory chip CHIP #3 includes one defective block. The memory chip CHIP #4 includes five defective blocks. The memory chip CHIP #5 includes one defective block. The memory chip CHIP #6 includes one defective block. The memory chip CHIP #7 includes one defective block.

Here, if a policy that a super block SB #to which two or more defective blocks belong is an unavailable block (of which physical block PB #is illustrated with single-hatching in a downward right diagonal direction) is applied, a super block SB #to which no defective block belongs and a super block SB #to which only one defective block belongs become available functional blocks (of which physical block PB #is illustrated with single-hatching in a downward left diagonal direction). Note that if a super block to which two or more defective blocks belong is also used, performance in access to such a super block is lower than performance in access to a super block to which one defective block belongs. Furthermore, in a case where there is a difference in the number of belonging defective blocks among super blocks, a variation in performance difference among the super blocks increases. Therefore, whether a super block to which one or more defective block belong is treated as an available functional block or an unavailable block is determined in consideration of the facts described above.

In FIG. 5(b), rearranged super blocks are illustrated. Here, the rearrangement is performed so that more available super blocks having a small number of defective blocks (in the example, the number of defective blocks is 0) are available. That is, by replacing a defective block with a specific physical block in each memory chip, many available super blocks become available. In the example, SB #0 to SB #23 are available functional blocks.

For example, in the memory chip CHIP #0, the physical block #PB3, the physical block #PB8, the physical block #PB13, the physical block #PB1 , the physical block #PB19, and the physical block #PB21, which are defective blocks, are respectively replaced with the physical block #PB25, the physical block #PB26, the physical block #PB28, the physical block #PB29, the physical block #PB30, and the physical block #PB31 that are included in the memory chip CHIP #0. Similarly, in the memory chip CHIP #1, the physical block #PB10 and the physical block #PB21, which are defective blocks, are respectively replaced with the physical block #PB30 and the physical block #PB31 that are included in the memory chip CHIP #1. The same applies to each of the other memory chips CHIP #2 to CHIP #7.

By replacing a defective block included in each memory chip with a specific physical block in this manner, 24 physical blocks PB #0 to PB #23 from the head of each memory chip become the available super blocks SB #0 to SB #23. However, the other physical blocks #PB24 to #PB31 of each memory chip become the unavailable super blocks SB #24 to SB #31. In the comparative example, the number of unavailable super blocks after the rearrangement is the same as the largest number of defective blocks of the memory chips. Therefore, the number of available rearranged super blocks in the memory system of the comparative example is limited to 24, which is the number of functional blocks in the memory chip CHIP #0 which includes the largest number of defective blocks, that is, eight defective blocks.

On the other hand, in the memory system 3 according to the present embodiment, the conversion information 52 for each memory chip 41 is determined in advance so that the number of defective blocks included in each of the super blocks #SB0 to #SB31 is equal to or smaller than the tolerable number. In a case where access to a physical block included in a memory chip 41 is requested, the controller 6 of the memory system 3 may perform a block number changing operation of converting a physical block number assigned to the physical block on the basis of the conversion information 52 corresponding to the memory chip 41. The controller 6 instructs the memory chip 41 to access the physical block to which the physical block number obtained by the conversion is assigned. That is, the controller 6 sends the physical block number, which is obtained by the conversion, to the memory chip 41.

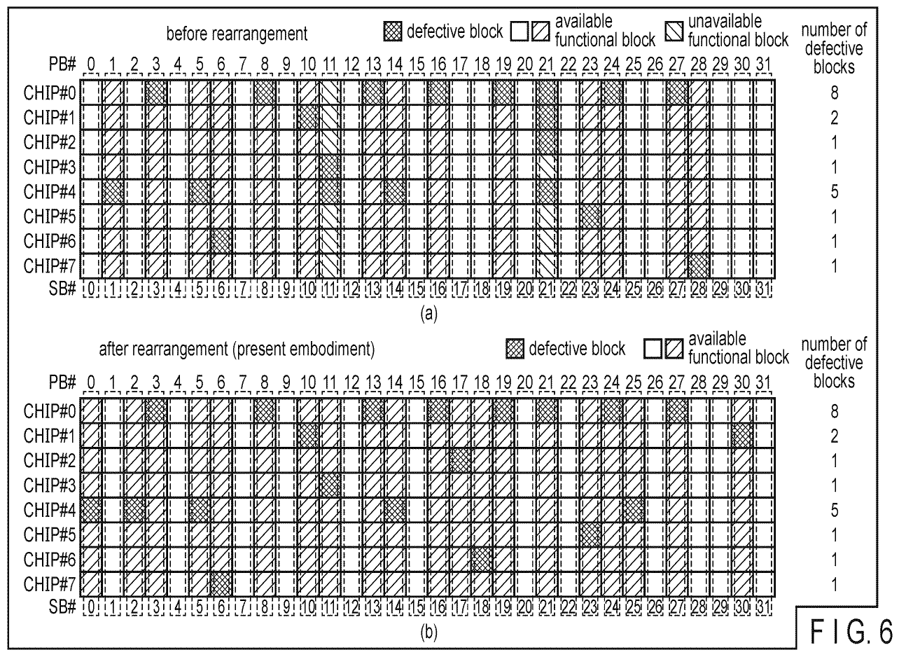

FIG. 6 illustrates (a) an example of an occurrence pattern of defective blocks in the plurality of memory chips 41 (before super block rearrangement), and (b) an example of a defective block pattern in which defective blocks are replaced with physical blocks other than the defective blocks in each memory chip 41(after super block rearrangement), in the memory system 3.

The example of the occurrence pattern of defective blocks illustrated in FIG. 6(a) is the same as that described above with reference to FIG. 5(a). In the examples of FIG. 5(a) and 6(a), the numbers of initial defective blocks that belong to the super blocks SB #0 to SB #31 are not leveled and differ among the super blocks. For example, the number of super blocks with no defective block is 16, the number of super blocks each including one defective block is 14, the number of super blocks each including two defective blocks is 1, and the number of super blocks each including four defective blocks is 1.

FIG. 6(b) illustrates an example of super blocks SB #0 to SB #31 (rearranged super blocks SB #0 to SB #31) that are obtained by rearranging the super blocks SB #0 to SB #31 illustrated in FIG. 6(a) on the basis of the conversion information 52 for each memory chip 41. A plurality of block numbers assigned to a plurality of respective physical blocks that belong to a super block are converted into a plurality of different or identical physical block numbers, respectively, based on the conversion information 52 for each memory chip 41. A rearranged super block corresponding to the super block includes the plurality of physical blocks to which the plurality of such converted physical block numbers are respectively assigned. The numbers of initial defective blocks that belong to the plurality of rearranged super blocks SB #0 to SB #31 , which are obtained by rearranging the plurality of super blocks on the basis of the plurality of pieces of conversion information 52, are leveled. Specifically, the number of super blocks with no defective block is 12, and the number of super blocks each including one defective block is 20. That is, the rearrangement is performed in such a way that the number of defective blocks belonging to each super block becomes zero or one.

In the example illustrated in FIG. 6(b), the physical block is replaced for each memory chip 41 so that the number of defective blocks included in each of the rearranged super blocks #SB0 to #SB31 is smaller than or equal to the tolerable number. In this case, the tolerable number is set to one, and the number of defective blocks included in each of the rearranged super blocks #SB0 to #SB31 is smaller than or equal to one. However, the tolerable number is not limited to one. The tolerable number may be set to, for example, an integer equal to or smaller than the average of the numbers of defective blocks included in the plurality of memory chips 41 respectively. Here, since the total number of defective blocks is 20 and the number of memory chips 41 is 8, the tolerable number is, for example, an integer that is equal to or smaller than 2.5 (=20/8). As a result, in the rearranged super blocks #SB0 to #SB31, it is possible to increase the number of available physical blocks as compared with the rearrangement of the physical blocks in the comparative example illustrated in FIG. 5(b) while limiting a difference in the number of defective blocks included in each super block within a certain range.

A frequency of the occurrence of defective block in the memory chips 41 tends to increase according to an increase in storage capacity and complication and difficulty of the manufacturing process. In addition, the number of defective blocks per memory chip 41 varies among the memory chips 41. The difference (variation) in the number of defective blocks among the memory chips 41 tends to increase as the number of steps of the manufacturing process of the memory chips 41 increases. For example, since a three-dimensional flash memory manufactured by stacking a plurality of layers requires a large number of complicated manufacturing processes, the difference (variation) in the number of defective blocks among the manufactured memory chips 41 tends to be relatively large. In addition, even in a memory chip in which the number of steps is not much larger than the three-dimensional flash memory, there may be a case where a large number of defective blocks are included only in some memory chips.

In the rearranged super blocks SB #0 to SB #31 described above with reference to FIG. 5(b), the number of available physical blocks in each memory chip is limited to the number of functional blocks in the memory chip CHIP #0 with the largest number of defective blocks. In the example of FIG. 5(b), the number of available physical blocks in each memory chip (the number of super blocks) is 24.

On the other hand, in the rearranged super blocks SB #0 to SB #31 illustrated in FIG. 6(b), the number of available physical blocks in each memory chip 41 is not limited to the number of functional blocks in the memory chip CHIP #0 with the largest number of defective blocks. In the example of FIG. 6(b), the number of all the 32 physical blocks (the number of super blocks) is allowed to be an available number. Further, as long as the sum of the numbers of defective blocks of all the memory chips 41 is not extremely large, the difference in the number of defective blocks among the rearranged super blocks SB #0 to SB #31 can be limited within the certain range. Therefore, a difference in the read performance/write performance among the rearranged super blocks SB #0 to SB #31 can be kept within a tolerable range. For example, since data is written into the rearranged super blocks in which the numbers of defective blocks are leveled, the performance difference is less likely to occur when reading the data. That is, in a case where the data is read in parallel, the number of physical blocks from which the data is readable in parallel is substantially the same among the rearranged super blocks.

In addition, if management information in a table format is used for managing a relationship between each rearranged super block and a set of physical blocks that belong to each rearranged super block, a large amount of memory resources are consumed for storing the management information. For example, a data size of the management information is [the sum of the numbers of physical blocks of all memory chips]×[the data length of a chip number+the data length of a block number]. For example, one memory chip 41 includes about 1000 to 2000 physical blocks. Further, [the data length of a chip number+the data length of a block number] is about 2 bytes. Therefore, the data size of the management information becomes very large. As a result, a consumption of resources for processing and storing the management information also increases. Further, the management information is referred to each time a super block is arranged and the performance of the memory system may deteriorate accordingly.

In the memory system 3 of the present embodiment, block numbers of physical blocks are converted in each memory chip 41 by block number conversion operations based on the conversion information 52 indicative of a mathematical rule (arithmetic and logical operations such as addition, subtraction, and order reversal), and physical blocks that belong to each super block are rearranged accordingly. One piece of conversion information 52 designates, for example, one of several available operations and a parameter used for the operation. Thus, the data size of the one piece of conversion information 52 is about several bits. In this case, the total data size of the conversion information 52 for each memory chip 41 is [the total number of chips (or the total number of planes)]×[several bits]. Therefore, in the memory system 3, the plurality of super blocks can be controlled at low cost.

FIG. 7 illustrates a distribution of the numbers of defective blocks across the plurality of super blocks SB #0 to SB #7 and a defective block pattern of each of the memory chips 41 (CHIP #0 to CHIP #3), before conversion using the conversion information 52 (an arrangement 81 on the left side of FIG. 7(a)) and after the conversion (an arrangement 82 on the right side of FIG. 7(a)). In addition, FIG. 7(b) illustrates an example of the conversion information 52 used for the conversion. By performing the conversion on each memory chip 41, the numbers of defective blocks locally scattered can be leveled among the blocks on the whole. This point will be described in more detail below.

First, here, a case where eight super blocks SB #0 to SB #7 are arranged in four memory chips CHIP #0 to CHIP #3 each including eight physical blocks will be explained. The memory chip CHIP #0 includes three initial defective blocks PB #0, PB #2, and PB #3. The memory chip CHIP #1 includes two initial defective blocks PB #2 and PB #4. The memory chip CHIP #2 includes three initial defective blocks PB #1, PB #2, and PB #3. In addition, the memory chip CHIP #3 includes no initial defective block. Similarly to FIGS. 5 and 6, a block illustrated with cross-hatching is a defective block.

### Arrangement 81 Before Conversion Using Conversion Information 52

The arrangement 81 of the super blocks SB #0 to SB #7 before the physical block numbers are converted by using the conversion information 52 is illustrated on the left side of FIG. 7(a). Specifically, the arrangement 81 of the super blocks SB #0 to SB #7 is determined by using the method of uniquely determining a set of physical block numbers of physical blocks that belong to a super block on the basis of its super block number and a mathematical rule.

Here, it is assumed that a super block includes a set of physical blocks that have a physical block number whose value is the same as its super block number. For example, the physical block PB #0 of the memory chip CHIP #0, the physical block PB #0 of the memory chip CHIP #1, the physical block PB #0 of the memory chip CHIP #2, and the physical block PB #0 of the memory chip CHIP #3 belong to the super block SB #0. In addition, for example, the physical block PB #1 of the memory chip CHIP #0, the physical block PB #1 of the memory chip CHIP #1, the physical block PB #1 of the memory chip CHIP #2, and the physical block PB #1 of the memory chip CHIP #3 belong to the super block SB #1. The same applies to the other super blocks SB #2 to SB #7.

In the arrangement 81 of the super blocks SB #0 to SB #7, for example, when access in which the physical block number “0” of the memory chip CHIP #1 is designated has been requested, the NAND I/F 13 (more specifically, the NAND controller 131) sends the physical block number “0” to the memory chip CHIP #1. As a result, the memory chip CHIP #1 is instructed to access the physical block PB #0. In addition, for example, when access in which the super block number “5” is designated has been requested, the NAND I/F 13 sends the physical block number “5” to each of the memory chips CHIP #0 to CHIP #3. As a result, each of the memory chips CHIP #0 to CHIP #3 is instructed to access the physical block PB #5.

In the arrangement 81, the numbers of initial defective blocks are not leveled among the super blocks. In other words, the initial defective blocks are locally scattered among the super blocks. Specifically, one initial defective block (the physical block PB #0 of the memory chip CHIP #0) belongs to the super block SB #0. One initial defective block (the physical block PB #1 of the memory chip CHIP #2) belongs to the super block SB #1. Three initial defective blocks (the physical block PB #2 of the memory chip CHIP #0, the physical block PB #2 of the memory chip CHIP #1, and the physical block PB #2 of the memory chip CHIP #2) belong to the super block SB #2. Two initial defective blocks (the physical block PB #3 of the memory chip CHIP #0 and the physical block PB #3 of the memory chip CHIP #2) belong to the super block SB #3. One initial defective block (the physical block PB #4 of the memory chip CHIP #1) belongs to the super block SB #4. No initial defective block belongs to each of the super blocks SB #5 to SB #7.

As described above, in the arrangement 81 of the super blocks SB #0 to SB #7 before the physical block numbers are converted by using the conversion information 52, the numbers of initial defective blocks are not leveled. Therefore, in the memory system 3, the conversion information 52 for each memory chip 41 is used to arrange (rearrange) the super blocks SB #0 to SB #7 so that the numbers of initial defective blocks are leveled across all the physical blocks in the super blocks SB #0 to SB #7.

The conversion information 52 corresponding to one memory chip 41 indicates, for example, at least one of (1) an operation of shifting (shift operation), by any integer, each of physical block numbers (block addresses) that are assigned to respective physical blocks in the memory chip 41, and (2) an operation of reversing (reverse operation) an order of the physical block numbers. The shift operation is, for example, either an operation of adding any integer (addition) to each of the physical block numbers (block addresses) that are assigned to the respective physical blocks in the memory chip 41 or an operation of subtracting any integer (subtraction) from each of the physical block numbers. The reverse operation is, for example, either an operation of rearranging, in a descending order, the physical block numbers arranged in an ascending order, or an operation of rearranging, in an ascending order, the physical block numbers arranged in a descending order. Note that the conversion information 52 may indicate any arithmetic operation that is not limited to the shift operation or the reverse operation. Hereinafter, a case where the conversion information 52 indicates the shift operation, the reverse operation, and an operation of a combination thereof will be explained.

The conversion information 52 for a memory chip 41 is represented by, for example, parameters that are respectively used in the shift operation and the reverse operation on each physical block number in the corresponding memory chip 41.

The parameter of the shift operation indicates an amount (that is, an offset amount) by which the physical block numbers in the corresponding memory chip 41 are shifted. In a case where the parameter is 0, the physical block numbers are not shifted. In a case where the parameter is a positive integer, each of the physical block numbers is increased by the integer. In a case where the parameter is a negative integer, each of the physical block numbers is decreased by the integer. Note that the physical block numbers are circularly handled. For example, in a case where each memory chip 41 includes eight physical blocks and the corresponding eight physical block numbers “0” to “7” are shifted by “+1”, the physical block number “7” is converted into the physical block number “0”. Furthermore, for example, in a case where the eight physical block numbers “0” to “7” are shifted by “−1”, the physical block number “0” is converted into the physical block number “7”.

The parameter of the reverse operation indicates whether or not to reverse the order of the physical block numbers in the corresponding memory chip 41. In the case of reversing the order of the physical block numbers, the parameter of the reverse operation is set to 1, for example. In the case of not reversing the order of the physical block numbers, the parameter of the reverse operation is set to 0, for example. Note that any value indicating whether or not to reverse the order of the physical block numbers may be set as the parameter of the reverse operation. The parameter of the reverse operation may indicate whether the order of the physical block numbers in the corresponding memory chip 41 is set to ascending order or descending order.

### Arrangement 82 After Conversion Using Conversion Information

FIG. 7(b) illustrates four pieces of conversion information 52-0, 52-1, 52-2, and 52-3 corresponding to the memory chips CHIP #0 to CHIP #3, respectively. Each of the pieces of conversion information 52-0, 52-1, 52-2, and 52-3 is represented by a parameter used for each of a shift operation and a reverse operation.

Specifically, the conversion information 52-0 indicates that a shift operation by “−1” is performed and a reverse operation is not performed for each physical block number of the memory chip CHIP #0. The conversion information 52-1 indicates that a shift operation by “−6” is performed and a reverse operation is not performed for each physical block number of the memory chip CHIP #1. The conversion information 52-2 indicates that a shift operation by “+1” is performed and a reverse operation is performed for each physical block number of the memory chip CHIP #2. The conversion information 52-3 indicates that neither a shift operation nor a reverse operation is performed for each physical block number of the memory chip CHIP #3.

On the right side of FIG. 7(a), the arrangement 82 is illustrated in which the numbers of defective blocks (more specifically, the numbers of initial defective blocks) are leveled in all the super blocks SB #0 to SB #7 by converting the physical block numbers with use of the conversion information 52 in FIG. 7(b).

Specifically, in the memory chip CHIP #0, each of the eight physical block numbers is shifted by “−1” on the basis of the conversion information 52-0, thereby being converted into a different physical block number. In the memory chip CHIP #1, each of the eight physical block numbers is shifted by “−6” on the basis of the conversion information 52-1, thereby being converted into a different physical block number. In the memory chip CHIP #2, each of the eight physical block numbers is shifted by “+1” and reversed in order on the basis of the conversion information 52-2, thereby being converted into a different physical block number. In the memory chip CHIP #3, each of the eight physical block numbers is neither shifted nor reversed in order on the basis of the conversion information 52-3, and thus, the physical block number remains unchanged after the conversion.

In this case, for example, when access in which the physical block number “0” of the memory chip CHIP #0 is designated has been requested, the NAND I/F 13 converts the physical block number “0” into the physical block number “7” on the basis of the conversion information 52-0 corresponding to the memory chip CHIP #0. Then, the NAND I/F 13 sends the physical block number “7” to the memory chip CHIP #0. As a result, the memory chip CHIP #0 is instructed to access the physical block PB #7.

In addition, for example, when access in which the super block number “0” is designated has been requested, the NAND I/F 13 converts the physical block number “0” into the physical block number “7” on the basis of the conversion information 52-0 corresponding to the memory chip CHIP #0. The NAND I/F 13 converts the physical block number “0” into the physical block number “2” on the basis of the conversion information 52-1 corresponding to the memory chip CHIP #1. The NAND I/F 13 converts the physical block number “0” into the physical block number “0” on the basis of the conversion information 52-2 corresponding to the memory chip CHIP #2. The NAND I/F 13 maintains the physical block number “0” on the basis of the conversion information 52-3 corresponding to the memory chip CHIP #3. Then, the NAND I/F 13 sends the physical block number “7” to the memory chip CHIP #0, sends the physical block number “2” to the memory chip CHIP #1, sends the physical block number “0” to the memory chip CHIP #2, and sends the physical block number “0” to the memory chip CHIP #3. As a result, the memory chip CHIP #0 is instructed to access the physical block PB #7, the memory chip CHIP #1 is instructed to access the physical block PB #2, the memory chip CHIP #2 is instructed to access the physical block PB #0, and the memory chip CHIP #3 is instructed to access the physical block PB #0. Note that since the physical block PB #2 of the memory chip CHIP #1 is a defective block, the NAND I/F 13 does not have to send the physical block number “2” to the memory chip CHIP #1.

In the arrangement 82 of the super blocks SB #0 to SB #7, the numbers of defective blocks are leveled among the super blocks. Here, one initial defective block belongs to any one of the super blocks SB #0 to SB #7. Thus, by converting the physical block numbers of the memory chips CHIP #0 to CHIP #3 with use of the corresponding pieces of conversion information 52-0, 52-1, 52-2, and 52-3, respectively, the super blocks SB #0 to SB #7 in which the numbers of initial defective blocks are leveled can be rearranged. That is, the super blocks SB #0 to SB #7 in the arrangement 82 are rearranged super blocks SB #0 to SB #7 in which the numbers of initial defective blocks are leveled based on the pieces of conversion information 52-0, 52-1, 52-2, and 52-3.

An example of conversion of physical block numbers using the conversion information 52 will be further described with reference to FIG. 8.

FIG. 8 illustrate (a) an example of physical block numbers before conversion, and (b) a first example, (c) a second example, and (d) a third example of physical block numbers after the conversion using the conversion information 52, in a memory chip 41. Here, it is assumed that the memory chip 41 in which the physical block numbers are converted is the memory chip CHIP #0. The memory chip CHIP #0 includes eight physical blocks PB #0 to PB #7. Among the eight physical blocks PB #0 to PB #7, three physical blocks PB #0, PB #2, and PB #3 illustrated with cross-hatching are defective blocks.

FIG. 8(a) illustrates the physical block numbers of the memory chip CHIP #0 that are not converted (i.e., the physical block numbers before the conversion) by using the conversion information 52. In a case where the physical block numbers before the conversion are used, for example, when access in which any physical block number of the memory chip CHIP #0 is designated has been requested, the NAND I/F 13 sends the physical block number to the memory chip CHIP #0. As a result, the memory chip CHIP #0 is instructed to access the physical block to which the physical block number is assigned. Note that the physical block numbers before the conversion are the same as the physical block numbers after conversion using the conversion information 52 in which a parameter of a shift operation is 0 and a parameter of a reverse operation is 0.

FIG. 8(b) illustrates the physical block numbers of the memory chip CHIP #0 that are converted (i.e., the physical block numbers after the conversion) by using first conversion information 52. The first conversion information 52 indicates an operation of shifting the physical block numbers by “−1”. Specifically, the first conversion information 52 designates “−1” as the parameter of the shift operation and designates “0” as the parameter of the reverse operation.

In a case where the first conversion information 52 is used, for example, when access in which any physical block number of the memory chip CHIP #0 is designated has been requested, the NAND I/F 13 performs conversion of subtracting one from the physical block number, thereby obtaining a different block number. The NAND I/F 13 sends the different physical block number to the memory chip CHIP #0. As a result, the memory chip CHIP #0 is instructed to access a physical block to which the different physical block number is assigned.

More specifically, for example, when access in which the physical block number “1” of the memory chip CHIP #0 is designated has been requested, the NAND I/F 13 performs conversion of subtracting one from the physical block number “1”, thereby obtaining the physical block number “0”. Hereinafter, similarly, when accesses in which the physical block numbers “2” to “7” are respectively designated have been requested, the NAND I/F 13 obtains the physical block numbers “1” to “6”, respectively. Note that when access in which the physical block number “0” of the memory chip CHIP #0 is designated has been requested, the NAND I/F 13 performs conversion of subtracting one from the physical block number “0”, thereby obtaining a physical block number “−1” in the calculation. However, since the physical block numbers “0” to “7” are circularly handled, the physical block number “−1” means the physical block number “7”. Therefore, in this case, the NAND I/F 13 obtains the largest physical block number “7” that corresponds to a physical block number that is one-number before the smallest physical block number “0”, as a result of the shift operation.

As described above, in a case where the first conversion information 52 is used, the physical block numbers “0” and “1” to “7” of the memory chip CHIP #0, which are each designated in an access request, are converted into the physical block numbers “7” and “0” to “6”, respectively.

FIG. 8(c) illustrates the physical block numbers of the memory chip CHIP #0 that are converted by using second conversion information 52. The second conversion information 52 indicates an operation of reversing the order of the physical block numbers. Specifically, the second conversion information 52 designates “0” as the parameter of the shift operation and designates “1” as the parameter of the reverse operation.

In a case where the second conversion information 52 is used, for example, when access in which any physical block number of the memory chip CHIP #0 is designated has been requested, the NAND I/F 13 performs conversion of reversing the order of the physical block number, thereby obtaining a different block number. The NAND I/F 13 sends the different physical block number to the memory chip CHIP #0. As a result, the memory chip CHIP #0 is instructed to access a physical block to which the different physical block number is assigned.

More specifically, for example, when access in which the physical block number “0” of the memory chip CHIP #0 is designated has been requested, the NAND I/F 13 performs conversion of reversing the order of the physical block number “0” in the physical block numbers “0” to “7”, thereby obtaining the physical block number “7”. That is, the first physical block number “0” is converted into the last physical block number “7” by reversing the order.

In this manner, in a case where the second conversion information 52 is used, the physical block numbers “0” to “7” of the memory chip CHIP #0, which are each designated in an access request, are converted into the physical block numbers “7” to “0”, respectively.

FIG. 8(d) illustrates the physical block numbers of the memory chip CHIP #0 that are converted by using third conversion information 52. The third conversion information 52 indicates an operation of reversing the order of the physical block numbers and shifting the physical block numbers by “−1”. Specifically, the third conversion information 52 designates “−1” as the parameter of the shift operation and designates “1” as the parameter of the reverse operation.

In a case where the third conversion information 52 is used, for example, when access in which any physical block number of the memory chip CHIP #0 is designated has been requested, the NAND I/F 13 performs conversion of reversing the order of the physical block number and subtracting one from the physical block number obtained by the reversal of the order, thereby obtaining a different block number. The NAND I/F 13 sends the different physical block number to the memory chip CHIP #0. As a result, the memory chip CHIP #0 is instructed to access a physical block to which the different physical block number is assigned.

More specifically, for example, when access in which the physical block number “0” of the memory chip CHIP #0 is designated has been requested, the NAND I/F 13 performs conversion of reversing the order of the physical block number “0” in the physical block numbers “0” to “7”, thereby obtaining the physical block number “7”. Then, the NAND I/F 13 subtracts one from the physical block number “7”, thereby obtaining the physical block number “6”.

In addition, for example, when access in which the physical block number “7” of the memory chip CHIP #0 is designated has been requested, the NAND I/F 13 performs conversion of reversing the order of the physical block number “7” in the physical block numbers “0” to “7”, thereby obtaining the physical block number “0”. Then, the NAND I/F 13 performs conversion of subtracting one from the physical block number “0”, thereby obtaining “−1”. Since the physical block numbers “0” to “7” are circularly handled, in a case where “−1” is obtained as a result of the operation, the NAND I/F 13 obtains the largest physical block number “7” corresponding to a physical block number that is one-number before the smallest physical block number “0”.

As described above, in a case where the third conversion information 52 is used, the physical block numbers “0” to “7” of the memory chip CHIP #0, which are each designated in an access request, are converted into the physical block numbers “6” to “0” and “7”, respectively.

By setting, for each memory chip 41, the conversion information 52 indicative of various combinations of the shift operation and the reverse operation, the controller 6 of the memory system 3 can manage the arrangement 82 of the super blocks SB #0 to SB #7 (that is, the rearranged super blocks SB #0 to SB #7) in which the numbers of initial defective blocks are leveled as illustrated in FIG. 7(a), for example.

The controller 6 is further configured to manage in-service defective blocks as well. Specifically, the controller 6 (more specifically, the block management module 141) manages defective blocks that include initial defective blocks and in-service defective blocks by using, for example, the management tables 53 and the sub-tables 54.

The management of the defective blocks using the management tables 53 and the sub-tables 54 will be described with reference to FIGS. 9 to 11. Here, it is assumed that the NAND flash memory 4 includes N memory chips CHIP #0 to CHIP #N−1. Each of the N memory chips CHIP #0 to CHIP #N−1 includes M physical blocks PB #0 to PB #M−1.

FIG. 9 illustrates examples of the management tables 53. Here, it is assumed that the tolerable number is two. One management table 53 corresponds to one super block. The management table 53 for a super block indicates, in a case where physical blocks that belong to the corresponding super block are converted into physical blocks on the basis of the conversion information 52 for each memory chip 41, whether or not the number of defective blocks included in the physical blocks after the conversion is equal to or smaller than the tolerable number. That is, the management table 53 for a super block indicates whether or not the number of defective blocks that belong to a rearranged super block, which is obtained by rearranging the corresponding super block, is equal to or smaller than the tolerable number.

The management table 53 includes, for example, fields as many as the tolerable number (here, two). The size of each field corresponds to, for example, the size of information by which one defective block belonging to a rearranged super block is uniquely identifiable. The size is, for example, 8 bits. Information (value) according to the number of defective blocks that belong to the rearranged super block is set in the management table 53. Specifically, in the management table 53, for example, information is set according to each of (A) a case where no defective block belongs to the rearranged super block, (B) a case where one defective block belongs to the rearranged super block, (C) a case where two defective blocks belong to the rearranged super block, and (D) a case where three or more defective blocks belong to the rearranged super block. An example of the management table 53 in each of the cases (A) to (D) will be described below.

(A) Case Where No Defective Block Belongs to Rearranged Super block

No defective block belongs to a rearranged super block 600. That is, N physical blocks that belong to the rearranged super block 600 are all functional blocks. The N physical blocks are included in the N memory chips CHIP #0 to CHIP #N−1, respectively.

In this case, a special key is set in all fields (here, two fields) of a management table 53A. The special key is, for example, “0xff”, and is a value for indicating that the rearranged super block 600 is in a specific state. The management table 53A in which the special key is set in all the fields indicates that no defective block belongs to the rearranged super block 600, which is obtained by rearranging the corresponding super block.

Therefore, based on the management table 53A corresponding to a super block, the controller 6 can determine that no defective block belongs to the rearranged super block 600 corresponding to the super block. In addition, the controller 6 can determine that the number of defective blocks that belong to the rearranged super block 600 is equal to or smaller than the tolerable number, based on the management table 53A.

(B) Case Where One Defective Block Belongs to Rearranged Super block

One defective block belongs to a rearranged super block 601. In the example illustrated in FIG. 9, among N physical blocks that belong to the rearranged super block 601, one physical block in the memory chip CHIP #0 is a defective block, and (N−1) physical blocks in the other memory chips CHIP #1 to CHIP #N−1 are functional blocks.

In this case, in a management table 53B, for example, the special key is set in the first field, and a value “0x00” that indicates the chip number of the memory chip CHIP #0 including the defective block is set in the second field. The number of chip numbers set in the management table 53B corresponds to the number of defective blocks that belong to the rearranged super block 601, which is obtained by rearranging the corresponding super block.

Therefore, based on the management table 53B corresponding to a super block, the controller 6 can determine that one defective block belongs to the rearranged super block 601 corresponding to the super block and the defective block is included in the memory chip CHIP #0. In addition, the controller 6 can determine that the number of defective blocks that belong to the rearranged super block 601 is equal to or smaller than the tolerable number, based on the management table 53B.

(C) Case Where Two Defective Blocks Belong to Rearranged Super block

Two defective blocks belong to a rearranged super block 602. In the example illustrated in FIG. 9, among N physical blocks that belong to the rearranged super block 602, two physical blocks that are included in the memory chips CHIP #1 and CHIP #N−1, respectively, are defective blocks, and (N−2) physical blocks that are included in the other memory chips CHIP #0 and CHIP #2 to CHIP #N−2, respectively, are functional blocks.

In this case, in the two fields of the management table 53C, a value “0x01” that indicates the chip number of the memory chip CHIP #1 including the defective block and a value “0x0N−1” that indicates the chip number of the memory chip CHIP #N−1 including the defective block are set. Note that, here, “0x0N−1” indicates a value of (N−1) represented in hexadecimal. The two values “0x01” and “0x0N−1” that respectively indicate the two chip numbers are set in the two fields in the management table 53C in a specific order. The specific order is, for example, an ascending order of the two values. In this case, in the management table 53C, the value “0x01” is set in the first field, and the value “0x0N−1” is set in the second field. The number of chip numbers set in the management table 53C corresponds to the number of defective blocks that belong to the rearranged super block 602, which is obtained by rearranging a corresponding super block.

Therefore, based on the management table 53C corresponding to a super block, the controller 6 can determine that two defective blocks belong to the rearranged super block 602 corresponding to the super block, and the two defective blocks are included in the two memory chips CHIP #1 and CHIP #N−1, respectively. In addition, the controller 6 can determine that the number of defective blocks that belong to the rearranged super block 602 is equal to or smaller than the tolerable number, based on the management table 53C.

(D) Case Where Three or More Defective Blocks Belong to Rearranged Super block

Three or more defective blocks belong to a rearranged super block 603. In the example illustrated in FIG. 9, among N physical blocks that belong to the rearranged super block 603, three physical blocks that are included in the memory chips CHIP #2, CHIP #N−2, and CHIP #N−1, respectively, are defective blocks, and (N−3) physical blocks that are included in the other memory chips CHIP #0, CHIP #1, and CHIP #3 to CHIP #N−3, respectively, are functional blocks.

In this case, in a management table 53D, a number (or identifier, hereinafter collectively referred to a sub-table number) of a sub-table 54 is set in the first field, and the special key is set in the second field. The order in which the sub-table number of the sub-table 54 and the special key are set in the two fields is not limited to this order but is a predetermined order. The sub-table number of the sub-table 54 set in the management table 53D is information by which the sub-table 54 associated with the management table 53D is uniquely identifiable. The sub-table 54 associated with the management table 53D includes information (block information) indicative of physical blocks that actually belong to a super block corresponding to the management table 53D.

In this way, since the management table 53D corresponding to a super block includes the sub-table number of the sub-table 54, the controller 6 can determine that three or more defective blocks belong to the rearranged super block 603 corresponding to the super block. That is, the controller 6 can determine that the number of defective blocks that belong to the rearranged super block 603 exceeds the tolerable number, based on the management table 53D.

As described above, the management table 53 indicates whether or not the number of defective blocks that belong to a rearranged super block, which is obtained by rearranging the corresponding super block, is equal to or smaller than the tolerable number. Therefore, the controller 6 can determine whether or not the number of defective blocks that belong to the rearranged super block, which is obtained by rearranging the corresponding super block, is equal to or smaller than the tolerable number on the basis of the information in the management table 53.

Next, the management table 53 in a case where the tolerable number is one will be described.

FIG. 10 illustrates examples of the management tables 53 in a case where the tolerable number is one. The management table 53 includes, for example, a 1-bit field and a 7-bit field. That is, the management table 53 is an 8-bit data string.

Information (value) according to the number of defective blocks that belong to a rearranged super block is set in each field. Specifically, in each field, information is set according to each of (E) a case where no defective block belongs to the rearranged super block or one defective block belongs to the rearranged super block, and (F) a case where two or more defective blocks belong to the rearranged super block. An example of the management table 53 in each of the cases (E) and (F) will be described below.

(E) Case Where No Defective Block or One Defective Block Belongs to Rearranged Super block

No defective block belongs to a rearranged super block 610. In the example illustrated in FIG. 10, all N physical blocks that belong to the rearranged super block 610 are all functional blocks.

In this case, a value (in FIG. 10, a value “0”) indicating that the number of defective blocks belonging to the rearranged super block 610 is equal to or smaller than the tolerable number is set in the first field (0-th bit) of a management table 53E. In the second field (the first to seventh bits), for example, the special key is set.

Note that in a case where one defective block belongs to the rearranged super block 610, a chip number of a memory chip 41 that includes the defective block is set in the second field of the management table 53E, for example.

Therefore, based on the management table 53E corresponding to a super block, the controller 6 can determine that the number of defective blocks that belong to the rearranged super block 610, which corresponds to the super block, is equal to or smaller than the tolerable number.

(F) Case Where Two or More Defective Blocks Belong to Rearranged Super block

Two defective blocks belong to a rearranged super block 611. In the example illustrated in FIG. 10, among N physical blocks that belong to the rearranged super block 611, two physical blocks that are included in the memory chips CHIP #0 and CHIP #N−1, respectively, are defective blocks, and (N−2) physical blocks that are included in the other memory chips CHIP #1 to CHIP #N−2, respectively, are functional blocks.

In this case, a value (in FIG. 10, a value “1”) indicating that the number of defective blocks belonging to the rearranged super block 611 exceeds the tolerable number is set in the first field of a management table 53F. In addition, the sub-table number of a sub-table 54 is set in the second field. The sub-table number of the sub-table 54 set in the management table 53F is information by which the sub-table 54 associated with the management table 53F is uniquely identifiable. The sub-table 54 associated with the management table 53F includes information (block information) indicative of physical blocks that actually belong to the super block corresponding to the management table 53F.

Therefore, since the management table 53F corresponding to a super block includes the sub-table number of the sub-table 54, the controller 6 can determine that two or more defective blocks belong to the rearranged super block 611 corresponding to the super block. That is, the controller 6 can determine that the number of defective blocks that belong to the rearranged super block 611 exceeds the tolerable number, based on the management table 53F.

FIG. 11 illustrates an example of a configuration of a super block identified based on the sub-table 54. FIG. 11 illustrates M rearranged super blocks SB #0 to SB #M−1 in a case where M physical blocks PB #0 to PB #M−1 are included in each of the N memory chips CHIP #0 to CHIP #N−1. Note that it is assumed that each of super blocks SB #0 to SB #M−1, which respectively correspond to the rearranged super blocks SB #0 to SB #M−1, includes a set of physical blocks that have a physical block number whose value is the same as its super block number. The physical block numbers (PB #) illustrated in FIG. 11 indicate physical block numbers before conversion based on the conversion information 52 is performed. Here, it is assumed that the tolerable number is two and the configuration of the management table 53 described above with reference to FIG. 9 (that is, the configuration including two fields) is used.

The plurality of management tables 53 correspond to the plurality of super blocks SB #0 to SB #M−1, respectively. In other words, it can be said that the plurality of management tables 53 correspond to the plurality of rearranged super blocks SB #0 to SB #M−1, respectively.

One defective block belongs to the rearranged super block SB #0. The defective block is a physical block of the memory chip CHIP #0. Therefore, in a management table 53-0 corresponding to the rearranged super block SB #0 (and the super block SB #0), the special key is set in the first field, and a value “0x00” indicative of the chip number of the memory chip CHIP #0 is set in the second field.

No defective block belongs to the rearranged super block SB #1. Therefore, in a management table 53-1 corresponding to the rearranged super block SB #1 (and the super block SB #1), the special key is set in all fields.

Two defective blocks belong to the rearranged super block SB #2. The two defective blocks are a physical block of the memory chip CHIP #1 and a physical block of the memory chip CHIP #N−1. Therefore, in a management table 53-2 corresponding to the rearranged super block SB #2 (and the super block SB #2), a value “0x01” indicative of the chip number of the memory chip CHIP #1 is set in the first field, and a value “0x0N−1” indicative of the chip number of the memory chip CHIP #N−1 is set in the second field.

Three defective blocks, that is, more defective blocks than the tolerable number, belong to the rearranged super block SB #M−2. The three defective blocks are a physical block 902 of the memory chip CHIP #2, a physical block 906 of the memory chip CHIP #N−2, and a physical block 907 of the memory chip CHIP #N−1. Therefore, in a management table 53-(M−2) corresponding to the rearranged super block SB #M−2 (and the super block SB #M−2), a value “1” indicative the sub-table number of a sub-table 54-1 is set in the first field, and the special key is set in the second field. Note that the sub-table number is not limited to a number, and may be information in any format by which the corresponding sub-table 54 is uniquely identifiable.

No defective block belongs to the rearranged super block SB #M−1. Therefore, in a management table 53-(M−1) corresponding to the rearranged super block SB #M−1 (and the super block SB #M−1), the special key is set in all fields.

Here, block information set in the sub-table 54-1 will be described. The sub-table 54-1 is associated with the management table 53-(M−2) that corresponds to the rearranged super block SB #M−2 (and the super block SB #M−2).

Before shipment, the rearranged super block SB #M−2 is arranged so that the tolerable number or fewer of initial defective blocks belong thereto on the basis of the conversion information 52. Therefore, one or more defective blocks, among the three defective blocks that belong to the rearranged super block SB #M−2, are in-service defective blocks. In the rearranged super block SB #M−2, for example, the physical block 902 of the memory chip CHIP #2 is an in-service defective block, and the physical block 906 of the memory chip CHIP #N−2 and the physical block 907 of the memory chip CHIP #N−1 are initial defective blocks.

When the number of defective blocks that belong to the rearranged super block SB #M−2 has exceeded the tolerable number due to the occurrence of the in-service defective block, the block management module 141 of the controller 6 creates the sub-table 54-1 associated with the management table 53-(M−2). The block management module 141 sets the sub-table number “1” of the sub-table 54-1 in the first field of the management table 53-(M−2). Then, the block management module 141 replaces a defective block that belongs to the rearranged super block SB #M−2 with a free physical block 71 that is selected by using a free block pool 7. In the example illustrated in FIG. 11, the defective block 907 of the memory chip CHIP #N−1, which belongs to the rearranged super block SB #M−2, is replaced with the free physical block 71.

Note that a free physical block managed in the free block pool 7 is, for example, a free physical block among one or more physical blocks that do not belong to any of the rearranged super blocks. That is, the free physical block managed by using the free block pool 7 is, for example, an unused physical block (that is, a physical block in which valid data is not stored) such as a redundant physical block in the NAND flash memory 4.

Alternatively, as a free physical block, an unused physical block that belongs to a rearranged super block having a margin for the tolerable number, or an unused physical block that belongs to a rearranged super block in which a margin of the number of unused physical blocks has been gained by performing the garbage collection may be used. The rearranged super block having a margin for the tolerable number is a rearranged super block for which a value obtained by subtracting the number of defective blocks belonging thereto from the tolerable number is equal to or larger than a threshold.

The block management module 141 sets, in the sub-table 54-1, information (block information) indicative of the N physical blocks that actually belong to the corresponding super block SB #M−1 (rearranged super block SB #M−1). The sub-table 54-1 includes, for example, N fields 910 to 917. N pieces of block information may be set in the N fields 910 to 917, respectively. The N pieces of block information respectively indicate the N physical blocks that actually belong to the super block SB #M−1. The block information indicates, for example, the chip number of a memory chip 41 that includes the corresponding physical block and the physical block number assigned to the physical block. Note that the block information may further include the channel number of a channel to which the memory chip 41 that includes the corresponding physical block is connected, and the plane number of a plane 42 of the memory chip 41 that includes the physical block.

In the example illustrated in FIG. 11, the block management module 141 sets, in each of the fields 910 to 916 of the sub-table 54-1, the block information indicative of each of the physical blocks 900 to 906 that belong to the rearranged super block SB #M−2. Then, the block management module 141 sets, in the field 917 of the sub-table 54-1, the block information indicative of the free physical block 71 with which the physical block 907, which belonged to the rearranged super block SB #M−2, has been replaced. The block information indicative of the free physical block 71 includes, for example, the chip number of a memory chip 41 that includes the free physical block 71, the channel number of a channel to which this memory chip 41 is connected, the plane number of a plane 42 of this memory chip 41, which includes the free physical block 71, and the physical block number assigned to the free physical block 71.

Note that the block management module 141 does not have to set, in the field 912, the block information indicative of the defective block 902. Similarly, the block management module 141 does not have to set, in the field 916, the block information indicative of the defective block 906.

In this manner, when the number of defective blocks that belong to a rearranged super block has exceeded the tolerable number due to an in-service defective block, the controller 6 replaces a defective block with a free physical block. As a result, the controller 6 can maintain the number of defective blocks that belong to each rearranged super block so as to be equal to or smaller than the tolerable number. In addition, the controller 6 can manage, by using the sub-table 54, the physical blocks that actually belong to a rearranged super block and include a free physical block with which a defective block is replaced.

Note that, for example, when an in-service defective block has occurred further in a rearranged super block arranged based on the sub-table 54, the block management module 141 replaces a defective block that belongs to the rearranged super block with a free physical block that is selected by using the free block pool 7. Then, the block management module 141 updates the sub-table 54 so as to change the physical block information indicative of the replaced defective block to physical block information indicative of the free physical block with which the defective block is replaced.

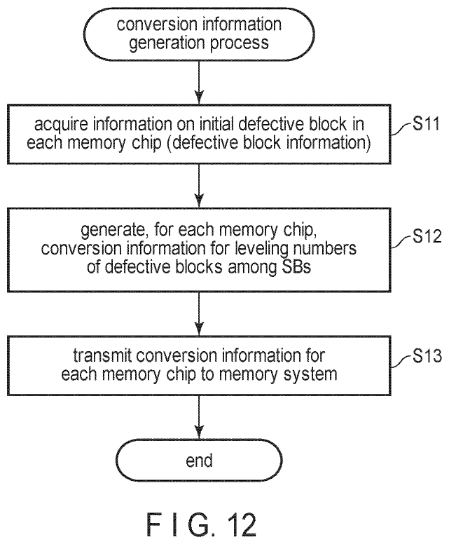

Next, processes executed in the information processing system 1 will be described with reference to FIGS. 12 to 15.

FIG. 12 is a flowchart illustrating an example of the procedure of a conversion information generation process executed in the host 2. The conversion information generation process is a process of generating the pieces of conversion information 52 for leveling, among the super blocks, the numbers of initial defective blocks included in each super block in consideration of an initial defective block that may be included in each of the memory chips 41. The CPU 21 of the host 2 executes the conversion information generation process for the memory system 3 before shipment of the memory system 3. The host 2 that executes the conversion information generation process is, for example, a manufacturing device of the memory system 3.

Note that in the memory system 3, it is assumed that the block numbers (block addresses) are assigned to the physical blocks in each memory chip 41, in a specific order. In addition, in the memory system 3, the super blocks are arranged according to a specific rule using the assigned block numbers. Each super block is a set of physical blocks that are obtained by allocating (selecting) at least one physical block from each of the memory chips 41.

First, the CPU 21 acquires defective block information from, for example, the memory system 3 (step S11). The defective block information indicates an initial defective block (or initial defective blocks) included in each memory chip 41. For example, the defective block information is acquired in the manufacturing process of the memory system 3 and is stored as the management data 4M. By using the defective block information, the CPU 21 generates, for each memory chip 41, the conversion information 52 for leveling the numbers of defective blocks among the super blocks (step S12). Specifically, the CPU 21 generates, for each memory chip 41, the conversion information 52 for making the number of defective blocks equal to or smaller than the tolerable number in every super block.

Then, the CPU 21 transmits the generated conversion information 52 for each memory chip 41 to the memory system 3 (step S13), and ends the conversion information generation process. The CPU 21 transmits the conversion information 52 to the memory system 3 at any timing in the manufacturing process of the memory system 3.

Through the conversion information generation process described above, the CPU 21 can generate the pieces of conversion information 52 for leveling, among the super blocks, the numbers of initial defective blocks included in each super block in consideration of the initial defective block that may be included in each of the memory chips 41.

Note that the conversion information generation process may be executed in the memory system 3. That is, a function of realizing the conversion information generation process may be provided in the memory system 3. The function may be provided, for example, in the block management module 141 of the CPU 14. In this case, the block management module 141 can generate the conversion information 52 for leveling the numbers of initial defective blocks among the super blocks in the memory system 3 that is, for example, a used product or a recycled product, as well as the one for the memory system 3 before shipment. The memory system 3 that is the used product or the recycled product is, for example, a memory system 3 that has been reset, a memory system 3 in which all pieces of user data have been erased, or a memory system 3 in which at least one of a deterioration in performance and a shortage in capacity has occurred due to wear of the NAND flash memory 4.

For example, in response to a request (signal) from an external device such as the host 2, the block management module 141 generates the conversion information 52 for each memory chip 41 by using the defective block information indicative of defective blocks in the NAND flash memory 4. Then, the block management module 141 sets the generated conversion information 52 for each memory chip 41 in the corresponding block number conversion circuit 31. Note that in a case where a range in the NAND flash memory 4 in which data is erasable is limited, the block number conversion circuit 31 may be configured to convert only the physical block numbers of physical blocks included in the limited range. Alternatively, the block management module 141 may generate the conversion information 52 for converting only the physical block numbers of the physical blocks within the limited range.

By generating the pieces of conversion information 52 for the memory system 3 that is the used product or the recycled product, for example, leveling of degrees of wear-out among blocks, reduction of performance variation among the super blocks according to rearrangement, and recovery of available storage capacity may be realized.

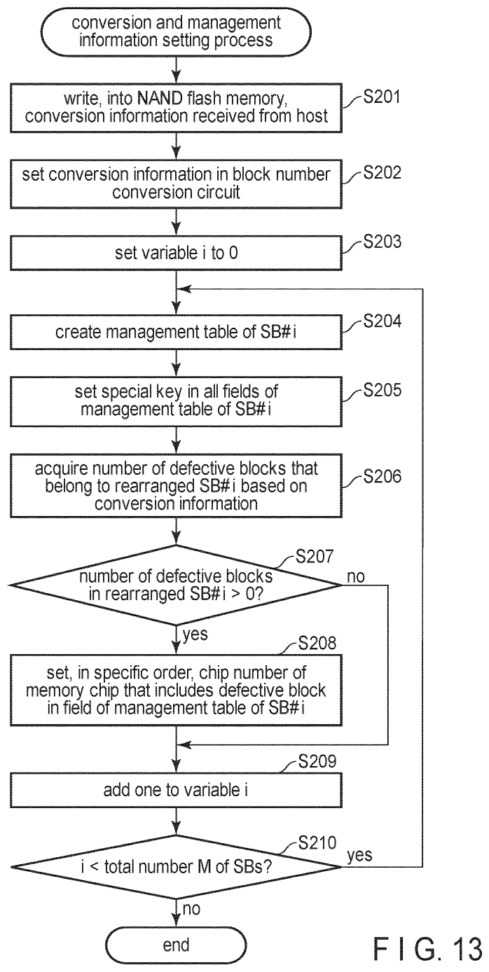

FIG. 13 is a flowchart illustrating an example of the procedure of a conversion and management information setting process executed in the memory system 3. The conversion and management information setting process is a process of setting the conversion information 52 for each memory chip 41 and the management table 53 for each super block, in the memory system 3. The CPU 14 of the memory system 3 executes the conversion and management information setting process, for example, when having received the conversion information 52 from the host 2 via the host I/F 11.

First, the CPU 14 writes, into the NAND flash memory 4, the conversion information 52 received from the host 2 as a part of the management data 4M (step S201).

Then, the CPU 14 sets the conversion information 52 in the block number conversion circuit 31 (step S202). Specifically, for example, the CPU 21 reads the conversion information 52 from the NAND flash memory 4, and stores the read conversion information 52 in a storage area of the block number conversion circuit 31. Alternatively, the CPU 21 may read the conversion information 52 from the NAND flash memory 4 and store the read conversion information 52 in the DRAM 5. In this case, the block number conversion circuit 31 refers to the conversion information 52 stored in the DRAM 5.

Next, the CPU 14 sets a variable i to 0 (step S203). The variable i is a variable for specifying one of M super blocks that are managed in the memory system 3. M is the total number of super blocks managed in the memory system 3. M is, for example, an integer of 2 or larger. The variable i is, for example, an integer from 0 to (M−1).

In step S204, the CPU 14 creates the management table 53 corresponding to an i-th super block (SB #i). The management table 53 includes, for example, fields whose number is the same as the tolerable number. The CPU 14 sets the special keys (for example, “0xff”) in all fields of the created management table 53 (step S205).

The CPU 14 acquires the number of defective blocks that belong to the i-th super block arranged based on the conversion information 52 (step S206). The i-th super block arranged based on the conversion information 52 is also referred as an i-th rearranged super block (rearranged SB #i). The CPU 14 determines whether or not the number of defective blocks that belong to the i-th rearranged super block is larger than 0 (step S207). That is, the CPU 14 determines whether or not the i-th rearranged super block includes any defective block.

In a case where the number of defective blocks in the i-th rearranged super block is larger than 0 (Yes in step S207), the CPU 14 sets, in a specific order, the chip number of each memory chip 41 that includes the defective block, in the field of the management table 53 corresponding to the i-th super block (step S208), and the process executed by the CPU 14 proceeds to step S209. The specific order is, for example, an ascending order of the chip numbers.

In a case where the number of defective blocks in the i-th rearranged super block is 0 (No in step S207), the process executed by the CPU 14 proceeds to step S209.

Next, the CPU 14 adds one to the variable i (step S209). The CPU 14 determines whether or not the variable i is smaller than the total number M of super blocks (step S210).

In a case where the variable i is smaller than the total number M of super blocks (Yes in step S210), the process executed by the CPU 14 returns to step S204. That is, the CPU 14 continues the process for creating the management table 53 corresponding to another super block on the basis of the updated variable i.

In a case where the variable i is equal to or larger than the total number M of super blocks (No in step S210), the CPU 14 ends the conversion and management information setting process.

Through the conversion and management information setting process described above, the CPU 14 can set the conversion information 52 for each memory chip, in the block number conversion circuit 31. The CPU 14 can create the management table 53 for each super block. In a case where the rearranged super block, which has been obtained by rearrangement based on the conversion information 52, includes a defective block, the CPU 14 can set the chip number of the memory chip 41 including the defective block, in the management table 53 of the corresponding super block.

Note that in the conversion and management information setting process, a case where the conversion information 52 is received from the host 2 has been explained. However, the conversion information 52 may have been already received from the host 2 and stored in the NAND flash memory 4. In this case, for example, when the memory system 3 is boot up, the CPU 14 reads the conversion information 52 from the NAND flash memory 4 and sets the read conversion information 52 in the block number conversion circuit 31.

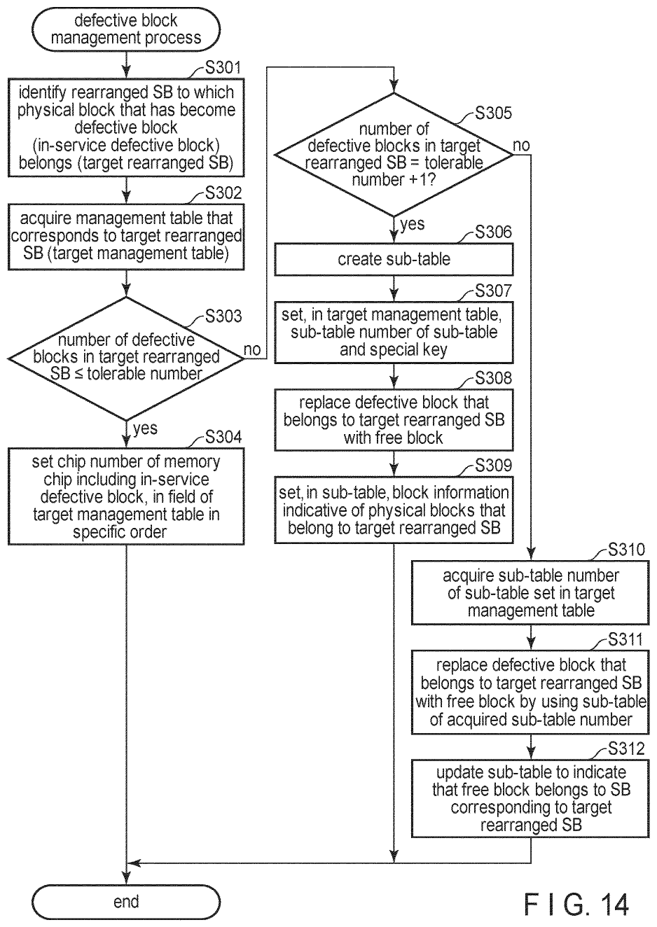

FIG. 14 is a flowchart illustrating an example of the procedure of a defective block management process executed in the memory system 3. The defective block management process is a process for managing a defective block that belongs to each rearranged super block. For example, the CPU 14 of the memory system 3 executes the defective block management process when a new defective block (that is, in-service defective block) has occurred in any of the M rearranged super blocks.

First, the CPU 14 identifies a rearranged super block to which the physical block that has newly become a defective block (that is, the in-service defective block) belongs, among the M rearranged super blocks that are obtained by rearrangement based on the conversion information 52 (step S301). The rearranged super block to which the in-service defective block belongs is also referred to as a target rearranged super block (target rearranged SB). The CPU 14 acquires the management table 53 of the super block corresponding to the target rearranged super block (step S302). Hereinafter, the acquired management table 53 is referred to as a target management table 53.

Then, by using the target management table 53, the CPU 14 determines whether the current number of defective blocks in the target rearranged super block, which includes the in-service defective block that has occurred, is equal to or smaller than the tolerable number (step S303). Specifically, for example, in a case where the special keys are set in all the fields of the target management table 53, and in a case where the special key and a chip number are set in the fields of the target management table 53, the CPU 14 determines that the current number of defective blocks in the target rearranged super block is equal to or smaller than the tolerable number. In a case where the chip numbers are set in all the fields of the target management table 53, and in a case where the sub-table number of the sub-table 54 and the special key are set in the fields of the target management table 53, the CPU 14 determines that the current number of defective blocks in the target rearranged super block exceeds the tolerable number.

In a case where the current number of defective blocks in the target rearranged super block is equal to or smaller than the tolerable number (Yes in step S303), the CPU 14 sets the chip number of a memory chip 41 including the in-service defective block, in the field of the target management table 53 in a specific order (step S304). In a case where the chip number of a memory chip 41 including a defective block is already set in any field of the management table 53, the CPU 14 sets the chip number of the memory chip 41 already set and the chip number of the memory chip 41 including the in-service defective block, in the fields of the management table 53, for example, in an ascending order. Then, the CPU 14 ends the defective block management process.

In a case where the current number of defective blocks in the target rearranged super block exceeds the tolerable number (No in step S303), the CPU 14 determines whether or not the current number of defective blocks in the target rearranged super block is equal to a value obtained by adding one to the tolerable number (step S305). That is, the CPU 14 determines whether or not the number of defective blocks in the target rearranged super block has exceeded the tolerable number in response to the occurrence of the in-service defective block.

In a case where the current number of defective blocks in the target rearranged super block is equal to the value obtained by adding one to the tolerable number (Yes in step S305), the CPU 14 creates a sub-table 54 (step S306). The CPU 14 sets the sub-table number of the created sub-table 54 and the special key, in the target management table 53 (step S307). The CPU 14 replaces one defective block that belongs to the target rearranged super block with one free physical block selected from the free block pool 7 (step S308). The defective block replaced with the free physical block may be an in-service defective block or may be an initial defective block. The CPU 14 sets block information indicative of the physical blocks that belong to the target rearranged super block, in the sub-table 54 (step S309). By using the sub-table 54, the CPU 14 is capable of identifying the physical blocks that belong to the target rearranged super block without using the conversion information 52. Then, the CPU 14 ends the defective block management process.

In a case where the current number of defective blocks in the target rearranged super block exceeds the value obtained by adding one to the tolerable number (No in step S305), the CPU 14 acquires the sub-table number of the sub-table 54 set in the target management table 53 (step S310). By using the sub-table 54 with the acquired sub-table number (hereinafter, referred to as a target sub-table 54), the CPU 14 replaces one defective block that belongs to the target rearranged super block with one free physical block selected from the free block pool 7 (step S311). The CPU 14 updates the target sub-table 54 to indicate that this free physical block belongs to the target rearranged super block (step S312). Specifically, the CPU 14 sets, in the field of the target sub-table 54 that corresponds to the defective block replaced with the free physical block, block information by which the free physical block is identifiable. The block information by which the free physical block is identifiable includes, for example, the chip number of a memory chip 41 including the free physical block and the physical block number of the free physical block. The block information by which the free physical block is identifiable may further include the channel number of a channel to which the memory chip 41 including the free physical block is connected, and the plane number of a plane of the memory chip 41 including the free physical block. Then, the CPU 14 ends the defective block management process.

Through the defective block management process described above, the CPU 14 can manage a defective block that belongs to each rearranged super block by using the management table 53 and the sub-table 54. Specifically, the CPU 14 can manage a relationship between the number of defective blocks that belong to each rearranged super block and the tolerable number by using the management table 53. In a case where the number of defective blocks that belong to the rearranged super block has exceeded the tolerable number, the CPU 14 can replace a defective block with a free physical block and manage the physical blocks that actually belong to the corresponding super block (rearranged super block) by using the sub-table 54.

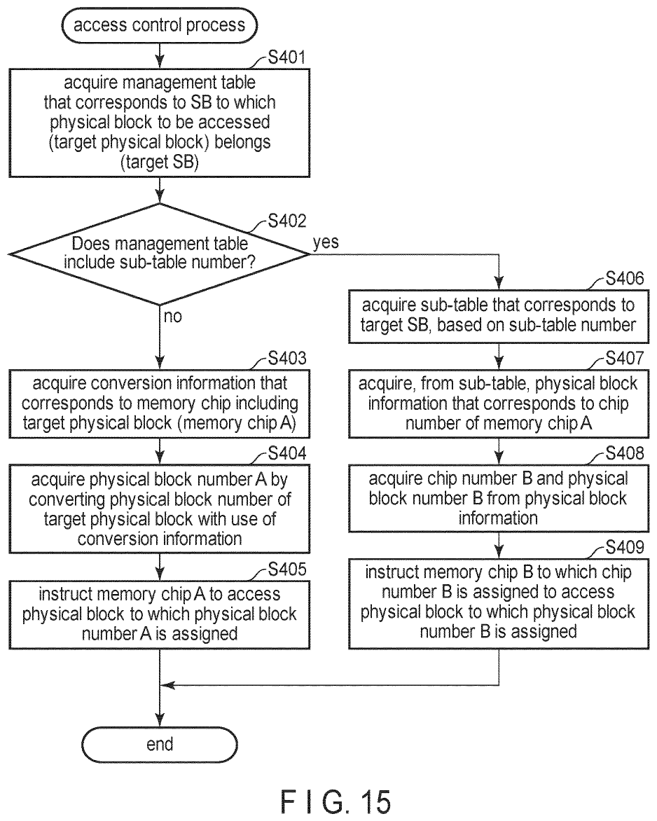

FIG. 15 is a flowchart illustrating an example of the procedure of an access control process executed in the memory system 3. The access control process is a process of controlling access to the NAND flash memory 4 via the NAND I/F 13. The NAND I/F 13 (more specifically, the NAND controller 131) executes the access control process in response to an access request by the CPU 14, for example. The access request by the CPU 14 is, for example, an access request according to an access command (for example, a read command or a write command) received from the host 2 or an access request in an internal process such as the wear-leveling or the garbage collection. Here, it is assumed that a physical block to be accessed (for example, the chip number and the physical block number) is designated in the access request.

First, on the basis of the chip number and the physical block number designated in the access request, the NAND I/F 13 acquires the management table 53 corresponding to a super block to which the physical block to be accessed (hereinafter, referred to as a target physical block) belongs (step S401). The super block to which the target physical block belongs is also referred to as a target super block. The NAND I/F 13 determines whether or not the acquired management table 53 includes the sub-table number (step S402). The determination corresponds to determination as to whether the N physical blocks that belong to a rearranged super block corresponding to the target super block include more defective blocks than the tolerable number.

In a case where the management table 53 does not include any sub-table number (No in step S402), that is, in a case where the N physical blocks that belong to the rearranged super block do not include more defective blocks than the tolerable number, the NAND I/F 13 acquires the conversion information 52 corresponding to a memory chip that includes the target physical block (step S403). Hereinafter, the memory chip that includes the target physical block is referred to as a memory chip A. The NAND I/F 13 converts the physical block number of the target physical block with use of the acquired conversion information 52, thereby acquiring a physical block number A (step S404). The physical block to which the physical block number A is assigned is a physical block that belongs to the rearranged super block. The NAND I/F 13 instructs the memory chip A to access the physical block to which the physical block number A is assigned (step S405), and ends the access control process. Specifically, the NAND I/F 13 sends, for example, at least the physical block number A to the memory chip A.

In a case where the management table 53 includes the sub-table number (Yes in step S402), that is, in a case where the N physical blocks that belong to the rearranged super block include more defective blocks than the tolerable number, the NAND I/F 13 acquires the sub-table 54 corresponding to the target super block on the basis of the sub-table number in the management table 53 (step S406). The NAND I/F 13 acquires, from the acquired sub-table 54, physical block information corresponding to the chip number of the memory chip A (step S407). For example, in a case where the chip number of the memory chip A is “1”, the NAND I/F 13 acquires the first physical block information in the sub-table 54. The NAND I/F 13 acquires a chip number B and a physical block number B from the acquired physical block information (step S408). A memory chip B to which the chip number B is assigned is either the same memory chip as the memory chip A or a memory chip different from the memory chip A. A physical block of the memory chip B to which the physical block number B is assigned is either a physical block that belongs to the rearranged super block or a physical block with which a defective block that belonged to the rearranged super block was replaced. The NAND I/F 13 instructs the memory chip B to access the physical block to which the physical block number B is assigned (step S409), and ends the access control process. Specifically, the NAND I/F 13 sends, for example, at least the physical block number B to the memory chip B.

Through the access control process described above, the NAND I/F 13 can control access to the NAND flash memory 4 in accordance with an access request. Specifically, in a case where access to a physical block is requested, the NAND I/F 13 controls a physical block to be actually accessed depending on whether the sub-table 54 corresponding to a super block to which the physical block (target physical block) belongs has been created. That is, the NAND I/F 13 controls the physical block to be actually accessed depending on whether the corresponding rearranged super block includes more defective blocks than the tolerable number.

In a case where a sub-table 54 has not been created, the NAND I/F 13 instructs a memory chip A including the target physical block to access a physical block that is determined based on the conversion information 52 of the memory chip A. On the other hand, in a case where the sub-table 54 has been created, by using the physical block information in the sub-table 54 that corresponds to the chip number of the memory chip A, the NAND I/F 13 instructs a memory chip B designated in the physical block information to access a physical block B designated in the physical block information.

In this manner, the NAND I/F 13 can control access to the NAND flash memory 4 in accordance with an access request by using the conversion information 52, the management table 53, and the sub-table 54. In addition, it is possible to prevent the access performance from differing among the super blocks by access control using the conversion information 52.

As described above, according to the present embodiment, it is possible to reduce deterioration of performance in access to the nonvolatile memory.

The plurality of memory chips 41 each include a plurality of first blocks. One or more of the plurality of first blocks of each of one or more of the plurality of memory chips 41 are initial defective blocks. The controller 6 accesses the plurality of memory chips 41 in parallel via the NAND I/F 13. The block management module 141 assigns a plurality of first block addresses to the plurality of first blocks of each of the plurality of memory chips 41, respectively. The block management module 141, the write control module 142, and the read control module 143, and the NAND I/F 13 control parallel access to the plurality of memory chips 41 in a plurality of super blocks (parallel access units). Each of the plurality of super blocks includes a plurality of second blocks. Each of the plurality of second blocks of each of the plurality of super blocks is one of the plurality of first blocks allocated one-by-one from each of the plurality of memory chips 41. The block management module 141 manages a plurality of pieces of conversion information 52 that correspond to the plurality of memory chips 41, respectively. Each of the plurality of pieces of conversion information 52 is specified so that the number of initial defective blocks included in each of the plurality of super blocks is equal to or smaller than a tolerable number. The block management module 141 rearranges the plurality of super blocks into a plurality of rearranged super blocks (rearranged parallel access units) respectively, by converting, based on the plurality of pieces of conversion information 52, one or more of the plurality of second blocks included in each of the plurality of super blocks, into one or more third blocks. The block management module 141 generates a plurality of management tables 53 that correspond to the plurality of super blocks, respectively. Each of the plurality of management tables 53 indicates whether or not the number of defective blocks included in each of the plurality of rearranged super blocks is equal to or smaller than the tolerable number.

The plurality of memory chips 41 include at least a first memory chip 41. The first memory chip 41 includes, as one of the plurality of first blocks, a fourth block. The plurality of pieces of conversion information 52 include at least first conversion information 52 corresponding to the first memory chip 41. The plurality of super blocks include at least a first super block. The first super block includes, as one of the plurality of second blocks, the fourth block. The plurality of rearranged super blocks include at least a first rearranged super block. The first rearranged super block is rearranged from the first super block. The plurality of management tables 53 include at least a first management table 53 corresponding to the first super block. When access to the fourth block has been requested, the NAND I/F 13 acquires the first management table 53, which corresponds to the first super block. In a case where the first management table 53 indicates that the number of defective blocks included in the first rearranged super block is equal to or smaller than the tolerable number, the NAND I/F 13 acquires the first conversion information 52, which corresponds to the first memory chip 41. The NAND I/F 13 converts one of the plurality of first block addresses assigned to the fourth block into a second block address, based on the first conversion information 52. The NAND I/F 13 instructs the first memory chip 41 to access one of the plurality of first blocks of the first memory chip 41 to which the second block address is assigned.

As described above, in the memory system 3, the plurality of super blocks (rearranged super blocks) are managed by using the conversion information 52 for each memory chip 41. In addition, in the memory system 3, the management table 53 for each super block is generated. The management table 53 indicates whether or not the number of defective blocks that belong to the corresponding rearranged super block is equal to or smaller than the tolerable number. By using the conversion information 52 and the management table 53, in the memory system 3, for example, access to each super block can be controlled at low cost as compared with a method of managing a set of physical blocks that belong to each of all rearranged super blocks by using information (the chip number, the physical block number, and the like) in a table format. In addition, it is possible to prevent the access performance from differing among the super blocks by access control using the conversion information 52. Therefore, in the memory system 3, it is possible to reduce deterioration of performance in access to the NAND flash memory 4.

Each of the various functions described in the embodiment may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiment may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a plurality of nonvolatile memory chips each including a plurality of first blocks, one or more of the plurality of first blocks of each of one or more of the plurality of nonvolatile memory chips being initial defective blocks; and
a controller electrically connected to the plurality of nonvolatile memory chips and configured to:
access the plurality of nonvolatile memory chips in parallel;
assign a plurality of first block addresses to the plurality of first blocks of each of the plurality of nonvolatile memory chips, respectively;
control parallel access to the plurality of nonvolatile memory chips in a plurality of parallel access units, each of the plurality of parallel access units including a plurality of second blocks, each of the plurality of second blocks of each of the plurality of parallel access units being one of the plurality of first blocks allocated one-by-one from each of the plurality of nonvolatile memory chips;
manage a plurality of pieces of conversion information that correspond to the plurality of nonvolatile memory chips, respectively, each of the plurality of pieces of conversion information being specified so that the number of initial defective blocks included in each of the plurality of parallel access units is equal to or smaller than a tolerable number;
rearrange the plurality of parallel access units into a plurality of rearranged parallel access units respectively, by converting, based on the plurality of pieces of conversion information, one or more of the plurality of second blocks included in each of the plurality of parallel access units, into one or more third blocks; and
generate a plurality of pieces of management information that correspond to the plurality of parallel access units, respectively, each of the plurality of pieces of management information indicating whether or not the number of defective blocks included in each of the plurality of rearranged parallel access units is equal to or smaller than the tolerable number.

2. The memory system according to claim 1, wherein
the plurality of nonvolatile memory chips include at least a first nonvolatile memory chip, the first nonvolatile memory chip including, as one of the plurality of first blocks, a fourth block,
the plurality of pieces of conversion information include at least first conversion information corresponding to the first nonvolatile memory chip,
the plurality of parallel access units include at least a first parallel access unit, the first parallel access unit including, as one of the plurality of second blocks, the fourth block,
the plurality of rearranged parallel access units include at least a first rearranged parallel access unit, the first rearranged parallel access unit being rearranged from the first parallel access unit,
the plurality of pieces of management information include at least first management information corresponding to the first parallel access unit, and
the controller is further configured to:
when access to the fourth block has been requested, acquire the first management information, which corresponds to the first parallel access unit; and
in a case where the first management information indicates that the number of defective blocks included in the first rearranged parallel access unit is equal to or smaller than the tolerable number,
acquire the first conversion information, which corresponds to the first nonvolatile memory chip;
convert one of the plurality of first block addresses assigned to the fourth block into a second block address, based on the first conversion information; and
instruct the first nonvolatile memory chip to access one of the plurality of first blocks of the first nonvolatile memory chip to which the second block address is assigned.

3. The memory system according to claim 2, wherein
the plurality of parallel access units further include a second parallel access unit,
the plurality of rearranged parallel access units further include a second rearranged parallel access unit, the second rearranged parallel access unit being rearranged from the second parallel access unit,
the controller is further configured to generate one or more pieces of sub-information that are respectively associated with one or more pieces of the plurality of pieces of management information,
the one or more pieces of sub-information include at least first sub-information that is associated with second management information, the second management information being one of the one or more pieces of management information and corresponding to the second parallel access unit, and
the controller is further configured to:
convert one or more third block addresses, which are respectively assigned to one or more of the plurality of second blocks included in the second parallel access unit, respectively into one or more fourth block addresses, based on the plurality of pieces of conversion information; and
in a case where the number of defective blocks included in the second rearranged parallel access unit that includes the one or more third blocks to which the one or more fourth block addresses are assigned, respectively, exceeds the tolerable number, replace a fifth block with a sixth block, the fifth block being one of the one or more third blocks and being a defective block, and generate the first sub-information that includes information indicative of the sixth block.

4. The memory system according to claim 3, wherein
the plurality of nonvolatile memory chips further include a second nonvolatile memory chip that includes the fifth block and the sixth block,
the plurality of pieces of conversion information further include second conversion information that corresponds to the second nonvolatile memory chip,
the second parallel access unit includes, as one of the plurality of second blocks, a seventh block,
a fifth block address that is one of the one or more third block addresses assigned to the seventh block is converted, as one of the one or more of fourth block addresses, into a sixth block address, based on the second conversion information,
the sixth block address is assigned to the fifth block included in the second rearranged parallel access unit, and
the controller is further configured to, when access to the seventh block has been requested:
acquire, the second management information corresponding to the second parallel access unit, which includes the seventh block;
acquire the first sub-information associated with the second management information; and
instruct the second nonvolatile memory chip to access the sixth block, based on the first sub-information.

5. The memory system according to claim 3, wherein
the controller is further configured to, upon the generation of the first sub-information, update the second management information to include information by which the first sub-information is identifiable.

6. The memory system according to claim 3, wherein
the controller is further configured to:
in a case where the number of defective blocks included in the second rearranged parallel access unit is one or larger and equal to or smaller than the tolerable number, generate the second management information that includes information by which a nonvolatile memory chip including the defective blocks is identifiable;
in a case where the number of defective blocks included in the second rearranged parallel access unit exceeds the tolerable number, generate the second management information that includes information indicative of the first sub-information and information indicative of a first value; and
in a case where the number of defective blocks included in the second rearranged parallel access unit is zero, generate the second management information that includes a plurality of pieces of information each indicating the first value.

7. The memory system according to claim 3, wherein
the controller is configured to generate the first sub-information that further includes information indicative of another one of the one or more third blocks than the fifth block included in the second rearranged parallel access unit.

8. The memory system according to claim 3, wherein
the sixth block is a free block among one or more blocks that are obtained by excluding the one or more third blocks included in the second rearranged parallel access unit, from the plurality of first blocks of the plurality of nonvolatile memory chips.

9. The memory system according to claim 3, wherein
the sixth block is an unused block that is included in the second rearranged parallel access unit for which a value obtained by subtracting, from the tolerable number, the number of defective blocks included in the second rearranged parallel access unit is equal to or larger than a threshold.

10. The memory system according to claim 2, wherein
the first conversion information indicates at least one of (1) a shift operation of shifting, by any integer, each of the plurality of first block addresses respectively assigned to the plurality of first blocks of the first nonvolatile memory chip, and (2) a reverse operation of reversing an order of the plurality of first block addresses respectively assigned to the plurality of first blocks of the first nonvolatile memory chip.

11. The memory system according to claim 10, wherein
the shift operation is either (A) an operation of adding any integer to each of the plurality of first block addresses respectively assigned to the plurality of first blocks of the first nonvolatile memory chip, or (B) an operation of subtracting any integer from each of the plurality of first block addresses respectively assigned to the plurality of first blocks of the first nonvolatile memory chip.

12. The memory system according to claim 10, wherein
the reverse operation is either (A) an operation of rearranging, in the descending order, the plurality of first block addresses respectively assigned to the plurality of first blocks of the first nonvolatile memory chip in the ascending order, or (B) an operation of rearranging, in the ascending order, the plurality of first block addresses respectively assigned to the plurality of first blocks of the first nonvolatile memory chip in the descending order.

13. The memory system according to claim 1, wherein
a block address assigned to each of the plurality of second blocks included in each of the plurality of parallel access units is determined based on an address that identifies the corresponding parallel access unit and a mathematical rule.

14. The memory system according to claim 1, wherein
each of the plurality of nonvolatile memory chips includes L planes, where L is an integer of two or larger, each of the L planes of each of the plurality of nonvolatile memory chips including one or more of the plurality of first blocks, and
each of the plurality of second blocks included in each of the plurality of parallel access units is one of the one or more of the plurality of first blocks allocated one-by-one from each of the L planes of each of the plurality of nonvolatile memory chips.

15. A method of controlling a plurality of nonvolatile memory chips, each of the plurality of nonvolatile memory chips including a plurality of first blocks, one or more of the plurality of first blocks of each of one or more of the plurality of nonvolatile memory chips being initial defective blocks, the method comprising:
accessing the plurality of nonvolatile memory chips in parallel;
assigning a plurality of first block addresses to the plurality of first blocks of each of the plurality of nonvolatile memory chips, respectively;
controlling parallel access to the plurality of nonvolatile memory chips in a plurality of parallel access units, each of the plurality of parallel access units including a plurality of second blocks, each of the plurality of second blocks of each of the plurality of parallel access units being one of the plurality of first blocks allocated one-by-one from each of the plurality of nonvolatile memory chips;
managing a plurality of pieces of conversion information that correspond to the plurality of nonvolatile memory chips, respectively, each of the plurality of pieces of conversion information being specified so that the number of initial defective blocks included in each of the plurality of parallel access units is equal to or smaller than a tolerable number;
rearranging the plurality of parallel access units into a plurality of rearranged parallel access units respectively, by converting, based on the plurality of pieces of conversion information, one or more of the plurality of second blocks included in each of the plurality of parallel access units, into one or more third blocks; and
generating a plurality of pieces of management information that correspond to the plurality of parallel access units, respectively, each of the plurality of pieces of management information indicating whether or not the number of defective blocks included in each of the plurality of rearranged parallel access units is equal to or smaller than the tolerable number.

16. The method according to claim 15, wherein
the plurality of nonvolatile memory chips include at least a first nonvolatile memory chip, the first nonvolatile memory chip including, as one of the plurality of first blocks, a fourth block,
the plurality of pieces of conversion information include at least first conversion information corresponding to the first nonvolatile memory chip,
the plurality of parallel access units include at least a first parallel access unit, the first parallel access unit including, as one of the plurality of second blocks, the fourth block,
the plurality of rearranged parallel access units include at least a first rearranged parallel access unit, the first rearranged parallel access unit being rearranged from the first parallel access unit,
the plurality of pieces of management information include at least first management information corresponding to the first parallel access unit, and
the method further comprises:
determining that access to the fourth block has been requested;
in response to determining that the access to the fourth block has been requested, acquiring the first management information, which corresponds to the first parallel access unit;
determining that the first management information indicates that the number of defective blocks included in the first rearranged parallel access unit is equal to or smaller than the tolerable number; and
in response to determining that the first management information indicates that the number of defective blocks included in the first rearranged parallel access unit is equal to or smaller than the tolerable number,
acquiring the first conversion information, which corresponds to the first nonvolatile memory chip;
converting one of the plurality of first block addresses assigned to the fourth block into a second block address, based on the first conversion information; and
instructing the first nonvolatile memory chip to access one of the plurality of first blocks of the first nonvolatile memory chip to which the second block address is assigned.

17. The method according to claim 16, wherein
the plurality of parallel access units further include a second parallel access unit,
the plurality of rearranged parallel access units further include a second rearranged parallel access unit, the second rearranged parallel access unit being rearranged from the second parallel access unit, and
the method further comprises generating one or more pieces of sub-information that are respectively associated with one or more pieces of the plurality of pieces of management information,
the one or more pieces of sub-information include at least first sub-information that is associated with second management information, the second management information being one of the one or more pieces of management information and corresponding to the second parallel access unit, and
the method further comprises:
converting one or more third block addresses, which are respectively assigned to one or more of the plurality of second blocks included in the second parallel access unit, respectively into one or more fourth block addresses, based on the plurality of pieces of conversion information;
determining that the number of defective blocks included in the second rearranged parallel access unit that includes the one or more third blocks to which the one or more fourth block addresses are assigned, respectively, exceeds the tolerable number;
in response to determining that the number of defective blocks included in the second rearranged parallel access unit exceeds the tolerable number, replacing a fifth block with a sixth block, the fifth block being one of the one or more third blocks and being a defective block, and generating the first sub-information that includes information indicative of the sixth block.

18. The method according to claim 16, wherein
the first conversion information indicates at least one of (1) a shift operation of shifting, by any integer, each of the plurality of first block addresses respectively assigned to the plurality of first blocks of the first nonvolatile memory chip, and (2) a reverse operation of reversing an order of the plurality of first block addresses respectively assigned to the plurality of first blocks of the first nonvolatile memory chip.

19. The method according to claim 15, wherein
a block address assigned to each of the plurality of second blocks included in each of the plurality of parallel access units is determined based on an address that identifies the corresponding parallel access unit and a mathematical rule.

20. The method according to claim 15, wherein
each of the plurality of nonvolatile memory chips includes L planes, where L is an integer of two or larger, each of the L planes of each of the plurality of nonvolatile memory chips including one or more of the plurality of first blocks, and
each of the plurality of second blocks included in each of the plurality of parallel access units is one of the one or more of the plurality of first blocks allocated one-by-one from each of the L planes of each of the plurality of nonvolatile memory chips.
